(19) United States
(12) Patent Application Publication
(10) Pub. No.: US 2023/0019045 A1
(43) Pub. Date: Jan. 19, 2023

(54) SYSTEMS AND METHODS OF FACILITATING TRADING A STORED VALUE CARD USING BLOCKCHAIN

(71) Applicant: Christian Suwiryo, San Ramon, CA (US)

(72) Inventor: Christian Suwiryo, San Ramon, CA (US)

(21) Appl. No.: 17/862,357

(22) Filed: Jul. 11, 2022

Related U.S. Application Data
(60) Provisional application No. 63/221,844, filed on Jul. 14, 2021.

(51) Int. Cl. G06Q 20/34; G06Q 20/38; G06Q 20/40; G06Q 20/12

(52) U.S. Cl. CPC G06Q 20/342; G06Q 20/389; G06Q 20/4014; G06Q 20/12

(57) ABSTRACT

The present disclosure provides a method of facilitating trading a stored value card using blockchain. Further, the method may include receiving a trading request associated with a stored value card from a user device, retrieving stored value card information associated with the stored value card, transmitting the trading request and the stored value card information to a second user device, receiving a confirmation from the second user device, issuing a second stored value card to a second user based on the confirmation, retrieving a first smart contract, executing the first smart contract, updating the stored value card information based on the executing of the first smart contract, generating a trading confirmation based on the updating, and storing the trading confirmation, a second stored value card information, and the stored value card information.

The current application claims a priority to the U.S. provisional patent application Ser. No. 63/221,844 filed on Jul. 14, 2021.

### FIELD OF THE INVENTION

The present disclosure generally relates to data processing. More specifically, the present disclosure relates to systems and methods of facilitating trading a stored value card using blockchain.

### BACKGROUND OF THE INVENTION

The field of data processing is technologically important to several industries, business organizations, and/or individuals.

Generally, ownerships of stored-value cards are either non-existent, loosely tied, or siloed within issuer systems. Such conditions and lack of transparency across critical systems created an environment prone to fraud, theft, or even money laundering due to anonymity and trace difficulties. In the event of misplacement or accidental loss, it may not be possible or hard for consumers to request merchants to retrieve and/or reissue cards. Further, a stored-value cardholder is an individual base, typically sent to the buyer or a recipient. Existing techniques of facilitating trading a stored value card using blockchain are deficient in several ways. For instance, current technologies do not allow multi-users to collaborate, such as co-using or co-consuming amongst family/friends/social. Furthermore, using current technologies, splitting an unused or partially used stored-value card into one or smaller denominations or values, for the purpose of regifting or reselling, etc., may not be possible. Furthermore, unwanted cards are typically sold or exchanged via intermediaries, brokers, or dealers often at a significantly discounted value. Further, current technologies do not remove such middlemen which ultimately allow direct consumer-to-consumer in buying, selling, and exchanging at less discounted value or even at the original value. Currently, consumers are likely not able to easily and effectively issue/sell/buy a new card sourced from previously owned cards, either unused or partially used by one or more owners.

Consumers are likely not able to easily assemble as a group to perform a collective or volume buy of a new card. Furthermore, current technologies do not track group purchase requests, and automatically issue / distribute directly to each buyer with the associated requested amount. Further, a business entity is likely not able to easily transfer/redeem cards issued by other businesses and automatically issue associated reimbursement.

Therefore, there is a need for methods and systems for facilitating trading a stored value card that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating trading a stored value card using blockchain. Further, the method may include receiving, using a communication device, a trading request associated with one or more stored value cards from one or more user devices associated with one or more users. Further, the trading request may indicate that the one or more users may want to perform a trading operation of the one or more stored value cards. Further, the method may include retrieving, using a storage device, one or more stored value card information associated with the one or more stored value cards from a distributed ledger network. Further, the one or more stored value card information may include a monetary value associated with the one or more stored value cards. Further, the method may include transmitting, using the communication device, the trading request and the one or more stored value card information to one or more second user devices associated with one or more second users. Further, the method may include receiving, using the communication device, a confirmation corresponding to the trading request from the one or more second user devices. Further, the method may include issuing, using a processing device, a second stored value card to the one or more second users based on the confirmation. Further, the second stored value card may be associated with a second stored value card information. Further, the method may include retrieving, using the storage device, a first smart contract from the distributed ledger network. Further, the method may include executing, using the processing device, the first smart contract. Further, the method may include updating, using the processing device, the one or more stored value card information based on the executing of the first smart contract. Further, the method may include generating, using the processing device, a trading confirmation based on the updating. Further, the method may include storing, using the storage device, the trading confirmation, the second stored value card information, and the one or more stored value card information in the distributed ledger network.

The present disclosure provides a system of facilitating trading a stored value card using blockchain. Further, the system may include a communication device configured for receiving a trading request associated with one or more stored value cards from one or more user devices associated with one or more users. Further, the communication device may be configured for transmitting the trading request and one or more stored value card information to one or more second user devices associated with one or more second users. Further, the communication device may be configured for receiving a confirmation corresponding to the trading request from the one or more second user devices. Further, the system may include a storage device communicatively coupled with the communication device. Further, the storage device may be configured for retrieving the one or more stored value card information associated with the one or more stored value cards from a distributed ledger network. Further, the one or more stored value card information may include a monetary value associated with the one or more stored value cards. Further, the storage device may be configured for retrieving a first smart contract from the distributed ledger network. Further, the storage device may be configured for storing a trading confirmation, a second stored value card information, and the one or more stored value card information in the distributed ledger network. Further, the system may include a processing device communicatively coupled with the communication device. Further, the processing device may be configured for issuing a second stored value card to the one or more second users based on the confirmation. Further, the second stored value card may be associated with the second stored value card information. Further, the processing device may be configured for executing the first smart contract. Further, the processing device may be configured for updating the one or more stored value card information based on the executing of the first smart contract. Further, the processing device may be configured for generating the trading confirmation based on the updating.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a new stored-value card platform and internal modules that may collectively accept requests from customers' requests, in accordance with some embodiments.

FIG. 2 is a flow diagram of a method for facilitating registering and enrolling a user to the network to establish user identity to participate in the blockchain network, in accordance with some embodiments.

FIG. 3 illustrates a global ecosystem that requires all users to be registered in order to participate in the blockchain, in accordance with some embodiments.

FIG. 4 illustrates a structure where both asset and actor's (users) identities are part of a block data structure, in accordance with some embodiments.

FIG. 5 is a flow diagram of an asset common lifecycle from its initial issuance until retirement, where owners' identities, token URI containing authorized co-users identities, asset status, asset value, and meta data are embedded on the block record, in accordance with some embodiments.

FIG. 6 is a continuation flow diagram of FIG. 5.

FIG. 7 is a flow diagram of a method for querying/pulling data out of the blockchain network, in accordance with some embodiments.

FIG. 8 is a flow diagram of a method for facilitating submitting a transaction and ultimately writing a record onto the blockchain, in accordance with some embodiments.

FIG. 9 is a flow diagram of a method for facilitating querying and writing block records at blockchain peer nodes using a smart contract, in accordance with some embodiments.

FIG. 10 is a continuation flow diagram of the method for facilitating writing block records at blockchain peer nodes using the smart contract, in accordance with some embodiments.

FIG. 11 is a flow diagram of a method for splitting an asset into a smaller value, with an option of regifting or reselling, in accordance with some embodiments.

FIG. 12 is a flow diagram of a method for transferring an asset, in accordance with some embodiments.

FIG. 13 is a flow diagram of a method for facilitating allowing customers to easily buy a new asset sourced from previously owned cards, in accordance with some embodiments.

FIG. 14 is a flow diagram of a method for facilitating group purchases request and asset issuance to each buyer within the purchase group, in accordance with some embodiments.

FIG. 15 is a flow diagram of a method for facilitating redeeming an asset, in accordance with some embodiments.

FIG. 16 is a screenshot of a stored-value card sample user interface being displayed on a mobile phone, in accordance with some embodiments.

FIG. 17 is a screenshot of a stored-value card sample user interface being displayed on a mobile phone, in accordance with some embodiments.

FIG. 18 is a screenshot of a stored-value card sample user interface being displayed on a mobile phone, in accordance with some embodiments.

FIG. 19 is an illustration of an online platform consistent with various embodiments of the present disclosure.

FIG. 20 is a block diagram of a computing device for implementing the methods disclosed herein, in accordance with some embodiments.

FIG. 21A illustrates a flowchart of a method of facilitating trading a stored value card using blockchain, in accordance with some embodiments.

FIG. 21B illustrates a continuation of the flowchart of the method of facilitating trading the stored value card using blockchain, in accordance with some embodiments.

FIG. 22 illustrates a flowchart of a method of facilitating trading a stored value card using blockchain, in accordance with some embodiments.

FIG. 23 illustrates a flowchart of a method of facilitating trading a stored value card using blockchain, in accordance with some embodiments.

FIG. 24 illustrates a flowchart of a method of facilitating trading a stored value card using blockchain, in accordance with some embodiments.

FIG. 25 illustrates a flowchart of a method of facilitating trading a stored value card using blockchain, in accordance with some embodiments.

FIG. 26 illustrates a flowchart of a method of facilitating trading a stored value card using blockchain, in accordance with some embodiments.

FIG. 27A illustrates a flowchart of a method of facilitating trading a stored value card using blockchain, in accordance with some embodiments.

FIG. 27B illustrates a continuation of the flowchart of the method of facilitating trading the stored value card using blockchain, in accordance with some embodiments.

FIG. 28 illustrates a block diagram of a system of facilitating trading a stored value card using blockchain, in accordance with some embodiments.

FIG. 29 illustrates a block diagram of the system of facilitating trading the stored value card using blockchain, in accordance with some embodiments.

FIG. 30 illustrates a block diagram of the system of facilitating trading the stored value card using blockchain, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating trading a stored value card using blockchain, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems of facilitating trading a stored value card using blockchain. Further, the disclosed system may include cryptographically distributed systems of record for stored-value cards (such as gift cards/vouchers, tickets, passes, and other types of cards or vouchers with a monetary value stored on them) along with the digital identities of primary holders, authorized usages of family, friends or social contacts. Further, the stored value cards may include prepaid access cards. Further, the disclosed system may be associated with a closely tied system design of users' digital identities with asset records, backed by a blockchain network. Further, the disclosed system produces a new platform with novelty capabilities to support collaborative and collective purchases, consumption, and trading of assets with social peers at stores and the marketplace. Further, distributed systems and ledgers associated with the disclosed system provide critical data consistency and transparency across members of the networks. Further, the disclosed system may provide an environment where consumers and businesses can verify asset authenticity and user eligibility. Further, the disclosed system may be configured for facilitating promoting trust, transaction, and operational safety, and help reduce illicit practices.

Further, the disclosed system may be associated with distributed systems, distributed ledgers of records, blockchain networks for end-to-end stored-value card transactions lifecycle management, from inception until decommission, including transactions such as issuance, adjustments, redeem, split, transfer, co-usages, on-hold, consolidation, decentralized marketplace for buying and selling, and retirement.

Further, the described series of new computing systems and methods closes many gaps, the aforementioned downsides, and pitfalls of the prior art. It will also overhaul many older systems, potentially changing consumers and market behaviors for the better, by producing a modern and frictionless platform for social collaboration and consumption of the stored-value cards (or prepaid access cards), tickets, and passes.

Further, the disclosed system may allow a stored-value card owner to authorize and grant permission for other people such as friends, family, and social, to use an asset on the owner's behalf. Further, a group of authorized users may use and redeem a stored-value card that belongs to other people and in a marketplace. Further, the disclosed system may allow the stored-value card owner to split an unused or partially used stored-value card (or a prepaid access card) into one or smaller denominations or values, for the purpose of regifting or reselling at the marketplace. Further, the disclosed system may allow consumers, either as an individual or as a group of consumers, to purchase the stored-value card from a marketplace sourced from previously owned cards, either unused or partially used by one or more owners (or the stored-value card owner). Further, the disclosed system may allow the consumers to assemble or join a group to perform a collective volume purchase from a marketplace, the system tracks group requests and automatically distributes resulting purchases to each buyer within the group. Further, the disclosed system may facilitate the replacement of lost/misplaced stored-value cards. (or lost prepaid access cards). Without manual reconciliation work, the disclosed system may be configured for verifying asset ownership, checking/auditing historical transactions, and issuing a replacement with remaining available. Further, the disclosed system may allow businesses to organize as a group. A stored-value card may be redeemed within the issuing business group and by other businesses within the platform.

Further, the disclosed system may function as a modern end-to-end stored-value card platform backed by a blockchain network that records transactions in immutable distributed ledgers for all necessary participants promoting data transparency and accuracy to help prevent fraud, theft, and other illicit practices.

Further, the disclosed system may be configured for managing stored-value card transactions in a trusted and transparent way where all participants have access to authentic, immutable, and distributed ledgers. Further, the disclosed system may function as a new and innovative stored-value card platform bringing together multiple leading-edge cloud services and blockchain technology in its ecosystem. Further, the disclosed system may include a blockchain technology at the center. The disclosed system utilizes the blockchain network which requires members to 1) register, and 2) join only after suitable verification of their cryptographic user identity encapsulated in a digital certificate such as X.509 or format variance, or other protocols such as zero-knowledge proof. Once registered and verified, the cryptographic user identity may be enrolled in a secured wallet, and may be used to verify the true originality of the user, and also to cryptographically sign all queries and transmission submissions. Overall, this produces unambiguous records of Who is doing/owning/transacting What and When—all in a cryptographic environment. In addition, the same copy of records is replicated across member organizations, hence distributed ledgers, creating confidence in data authenticity and accuracy, promoting trust and transparency of all parties participating in the disclosed stored-value card platform.

Further, the disclosed stored-value card platform may include the blockchain network, gateways to external businesses and social network entities, graph and API routings, and a series of computing services on-premise and in the cloud. Further, the stored-value card platform with the blockchain network may allow certificate authorities to issue certificate identities to users and cryptographic certificates for users' identities. Further, the stored-value card platform may facilitate providing wallets for storing user identity certificates and channels for further isolating data and communication privacy. Further, the stored-value card platform may be associated with endorsement policies, smart contracts for reading and writing data on ledgers, and distributed ledgers across all participants of the network.

Further, the disclosed stored-value card platform with gateways to external businesses and social network entities may include an interface with popular social networks such as the likes of Facebook™/Twitter™/TikTok™ etc., fintech services such as the likes of Plaid™/Stripe™/Dwolla™ etc, communication services such as the likes of Twilio™/Mailchimp™/etc, business directory services such as the likes of Yelp™/etc, eCommerce services such as the likes of Shopify™/WooCommerce™/BigCommerce™ etc.

Further, the stored-value card platform with computing services on-premise and in the cloud may provide various micro-services fronted by REST APIs and databases. Further, the stored-value card platform may be associated with queuing and stream systems, services discovery, containerization and cluster orchestrators, and various cloud platform providers such as the likes of AWS™/GCP™/Azure™/IBM™/DigitalOcean™ etc.

Further, the stored-value card platform may be associated with API gateways, graphs, and API routings to secure and direct communication traffic to various microservices, blockchain networks, gateways to external businesses and social networks, and cloud platforms. Further, the stored-value card platform may be associated with a system where digital users' identities with asset records are closely tied, which produces unambiguous records of who is doing/owning/transacting what and when all in a cryptographic environment. Further, the stored-value card platform tracks and records end-to-end stored-value card transactions lifecycle, from inception until decommission, including transactions such as issuance, adjustments, redeem, split, transfer, co-usages, on-hold, consolidation, decentralized marketplace for buying and selling, and retirement. Further, the stored-value card platform replicates ledger data across network members, hence the term distributed ledgers, creating an environment where consumers and businesses can verify assets authenticity and users eligibility, promoting trust, transaction and operational safety, and helping reduce illicit practices. Further, the stored-value card platform makes a trading environment of direct consumer-to-consumer without intermediaries possible, to buy/sell/exchange assets sourced from previously owned assets with remaining values, either unused or partially used, from one or more originating owners. Further, the stored-value card platform allows direct collaborations amongst consumers to assemble as a group to perform collective volume purchases with an end-to-end transparency process from initiating submissions to asset distributions. Further, the stored-value card platform allows direct collaborations amongst businesses to redeem an asset issued by other businesses. Further, the stored-value card platform makes novelty capabilities possible such as supporting social and business collaborations directly without intermediaries. Social consumers can collaborate and make collective purchases, and consume and co-use an asset with friends, family, and social peers. Businesses can collaborate with other businesses to redeem an asset issued by a different business organization.

Further, guildcard, an exemplary embodiment of the disclosed stored value card herein, may be used like a gift card, but with so much more. Further, the guildcard may bring society together and empower small businesses. Further, the guildcard may be associated with the blockchain to assure card authenticity and eliminate counterfeiting. Further, a user may share cards with friends, family, and social. Further, the disclosed system may automatically arrange reimbursement to the user for the amount consumed. Further, the guildcard may be associated with the association of businesses with similar interests or pursuits, that may be based on geography, lifestyle, interests, etc. Further, the guildcard may be used at businesses within the issuing guild group. Further, the user may signup to use the guildcard. Further, the user may download a software application (or app), link bank accounts, and invite family, friends, etc. Further, the guildcard may show up in the app and the user may share it with family/friends (optional). Further, the user may use it at businesses and guild groups. Further, the guildcard may be contactless (NFC/QR). Further, the user may trade/sell when no longer needed (optional) at all within the software application.

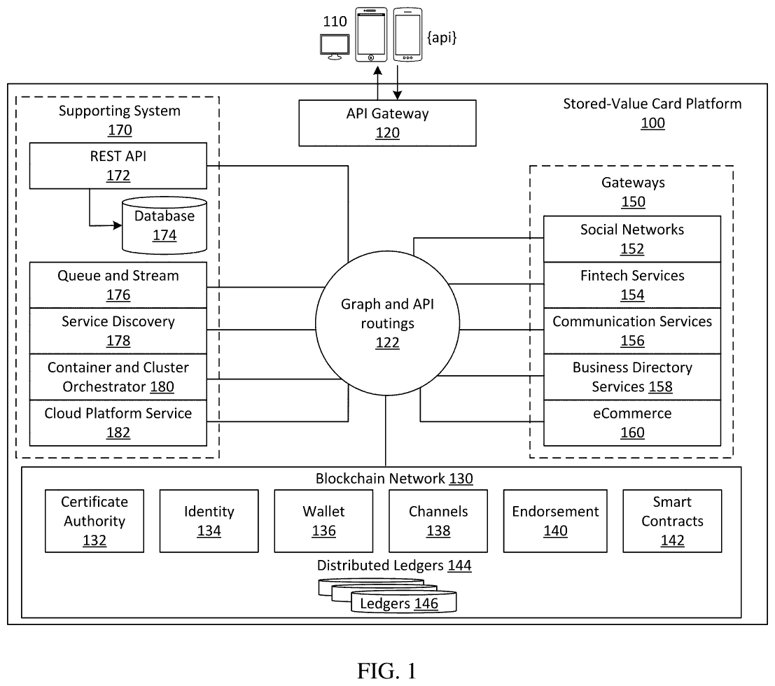

FIG. 1 illustrates a new stored-value card platform (100) and internal modules that may collectively accept requests from customers' requests (110), in accordance with some embodiments. Accordingly, an API gateway (120) such as the likes of Kong/Istio/Apigee/other ingress-controller secures and takes all requests from customers (110) and serves platform perimeter defense which includes authentication, valid API keys, routing, rate limiting, billing, monitoring, analytics, policies, alerts, and platform security. If a request is authenticated, verified, and valid, the API gateway (120) passes requests to a central graph and API routings (122) which then route them to appropriate microservices.

Further, the stored-value card platform (100) may include 3 key modules, namely, Blockchain Network (130), a series of Gateways (150), and supporting systems (170). Further, at the heart of the disclosed platform is the Blockchain Network (130), where all cryptographic records related to user identity, transactions, and assets reside. Further, a certificate authority (132) may be the backbone of modern internet security, it serves as a trusted agent to issue certificate identity (134) to users, and store the certificate identity (134) in a wallet (136). Further, channels (138) may be created to further segment data and its confidentiality within the network. Further, an endorsement Policy (140) contains a set of rules for network members to agree to and ultimately endorse/approve data read and written. Further, smart contracts (142) may take that endorsement and execute the read/write logic across peers' peers' distributed networks and ledgers. The resulting block records are stored in peer Ledgers (146) and may be replicated across peers, hence the Distributed Ledgers (144). Further, the series of Gateways (150) serves as an interface layer to other external businesses varying from Social Networks (152) such as the likes of Facebook/Twitter/etc., Fintech Services (154) such as the likes of Plaid/Stripe/Dwolla, etc., Communication Services (156) such as the likes of Twilio/Sendgrid/MailChimp/AWS SES/etc., Business Directory Services (158) such as Yelp, eCommerce (160) such as the likes of Amazon/Shopify/BigCommerce/Etsy/WooCommerce/Groupon, etc. Further, the supporting systems (170) consist of all internal infrastructure required to support high volume and elastic computing services. Further, the supporting systems (170) consist of a REST API (172) and a supporting databases (174), queuing and streaming services (176) such as the likes of Kafka, Service Discovery (178), Container and Cluster Orchestration (180) such as the likes of Docker/Kubernetes, and Cloud Platform Services (182) such as the likes of AWS/GCP/Azure/IBM/DigitalOcean, etc.

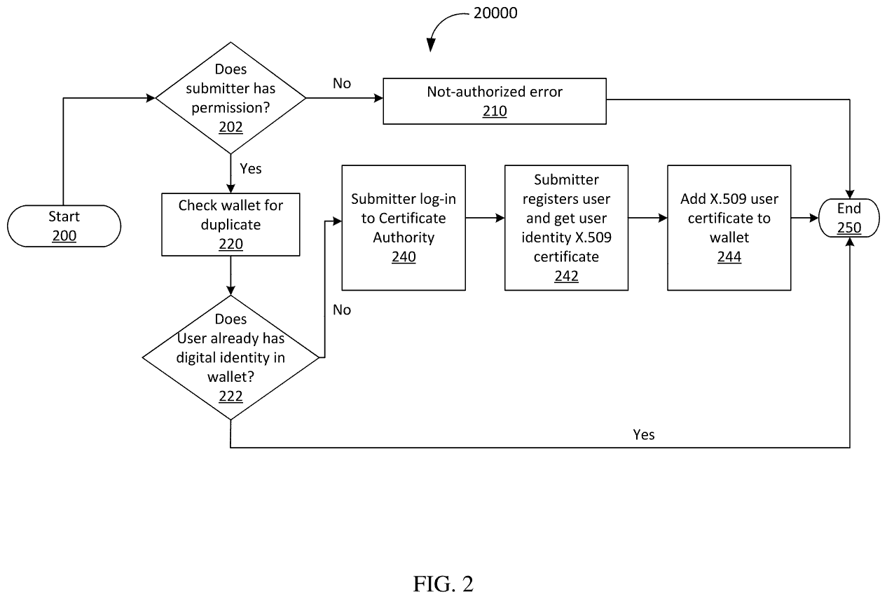

FIG. 2 is a flow diagram of a method (20000) for facilitating registering and enrolling a user to the network to establish user identity to participate in the blockchain network, in accordance with some embodiments. Accordingly, the method (20000) may include a starting step (200) with a series of upfront checks. Further, at (202), the method (20000) may include verifying whether the submitter has the necessary permission. Further, at (220), the method (20000) may include checking for a duplicate wallet. Further, at (222), the method (20000) may include verifying if the user identity has been previously created. This is necessary to prevent duplicative user identity. If any of the checks fail, at (210), the method (20000) may include rejecting registration and enrollment requests and sending out either a submitter Not-authorized error. If checks did not fail, at (240), the method (20000) may include an authorized submitter authenticating him/herself to the Certificate Authority provider. Once authenticated, at (242), the method (20000) may include the submitter registering by supplying user information and upon success may receive a user identity encapsulated in X.509 digital certificate or other protocols such as zero-knowledge proof. Further, at (244), the method (20000) may include adding X.509 user certificate to the wallet. Further, the resulting X.509 user identity is then stored in a wallet, which then can be used to verify user identity and sign transactions in the blockchain network. Further, at (250), the method (20000) may include ending step.

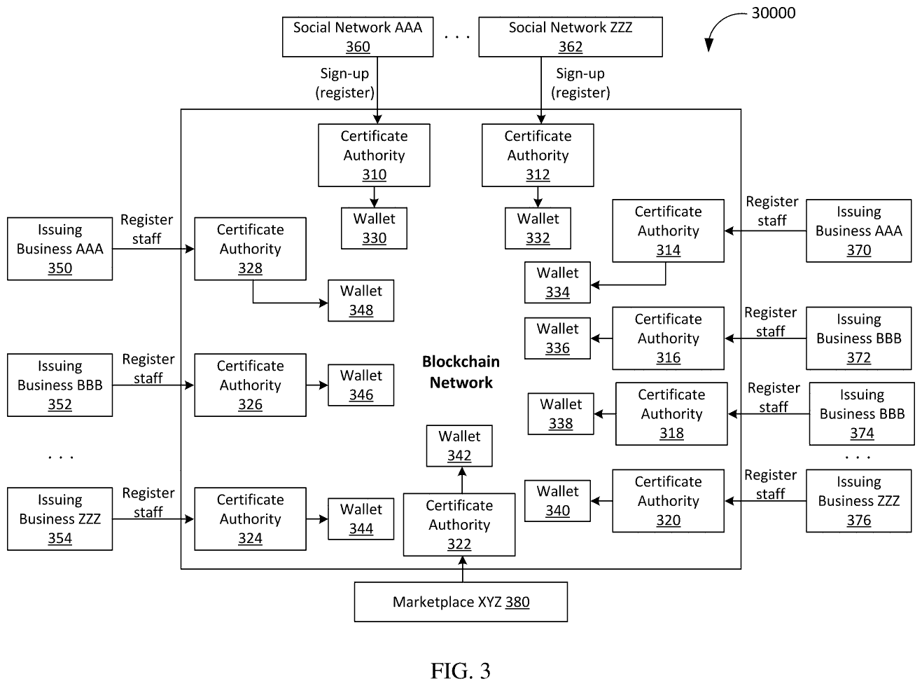

FIG. 3 illustrates a global ecosystem (30000) that requires all users to be registered in order to participate in the blockchain, in accordance with some embodiments. Accordingly, each organization with different purposes anywhere from a card issuing businesses (350)(352)(354), marketplaces(380), redeeming stores (370)(372)(374)(376), social networks (360)(362) must have their staff registered. Due to real estate, the FIG. 3 depicts few representative organization entities, but in practice may have a higher number of organizations. Further, a blockchain network 30002 associated with the disclosed system is capable of deploying multiple Certificate Authorities (310)(312)(314)(316)(318)(320)(322)(324)(326)(328) from a variety of companies, to name a few Symantec Verisign/GeoTrust/DigiCert/Hyperledger/GoDaddy/etc. Further, an organization may select unique certificate providers depending on their organization's policies. The blockchain network 30002 is also capable of deploying multiple wallets (330)(332)(334)(336)(338)(340)(342)(344)(346)(348), each wallet stores a cryptographic user identity or other protocols such as zero-knowledge proof. The wallet may be exclusive to an organization that supports organization staffing/user privacy.

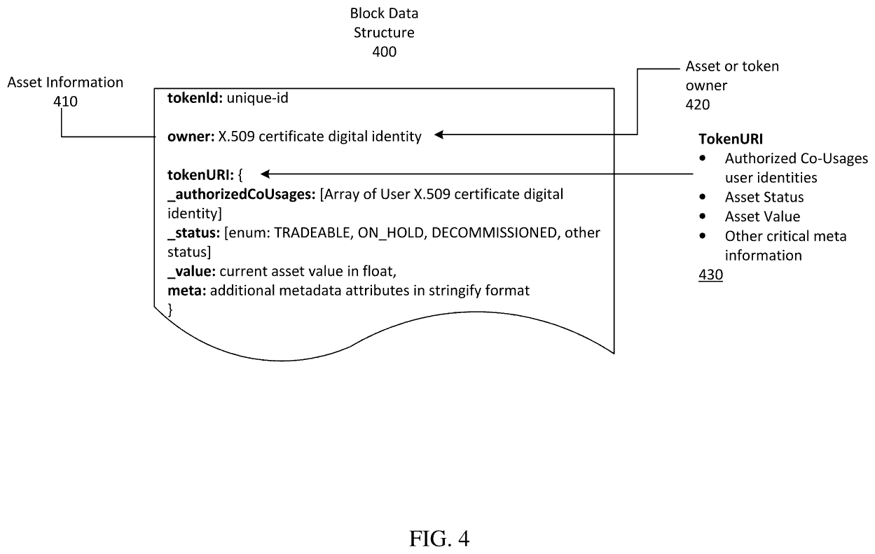

FIG. 4 illustrates a structure where both asset and actor's (users) identities are part of a block data structure (400), in accordance with some embodiments. Accordingly, an asset information (410) may store a unique identifier of an asset and owner's user identity (420). Additional block data are stored in tokenURI (430), which includes critical asset information such as authorized co-usages user identities which is a list of user identities granted permission to use this asset by the asset or token owner/primary holder (420), asset status, asset value, and meta data containing critical information supporting the block.

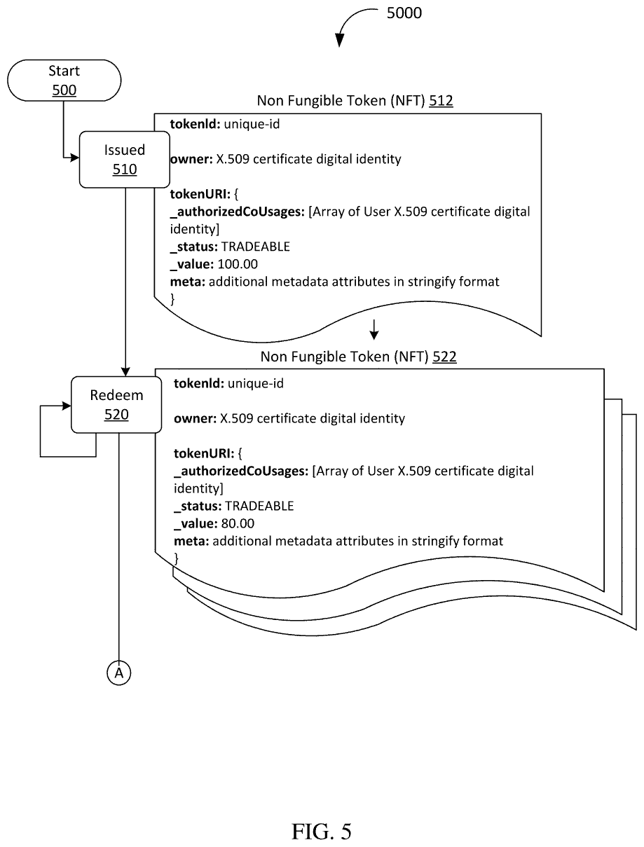

FIG. 5 is a flow diagram of an asset common lifecycle 5000 from its initial issuance until retirement, where owners' identities, token URI containing authorized co-users identities, asset status, asset value, and meta data are embedded on the block record, in accordance with some embodiments. Accordingly, at (500), the asset common lifecycle (5000) may include a starting step. Further, at (510), the asset common lifecycle 5000 may include issuing an asset. Further, when an asset is issued, a non-fungible token (NFT) is minted with block data (512) containing owners' identity, token URI describing authorized co-users, token status, token value, and critical meta data. Further, at (510), the asset common lifecycle 5000 may include redeeming step. Further, a redeem activity may trigger an update to the non-fungible token in which a resulting block (522) is distributed. Further, at (530), the asset common lifecycle 5000 may include retiring the step. Further, when an asset is retired, either due to no-remaining value or other reasons, the non-fungible token (NFT) status is updated to DECOMMISSIONED. Further, the asset common lifecycle (5000) may be associated with a retire block record (532) of the NFT. This ends the lifecycle of an asset. Other sets of transactions such as Adjust-Value, Split, Transfer, Co-Usage, On-Hold, and On-Hold-To-Sell follow the patterns of embedding the owner's user identity, token URI containing a list of authorized co-usage users' identities, token status, token value, and critical meta data.

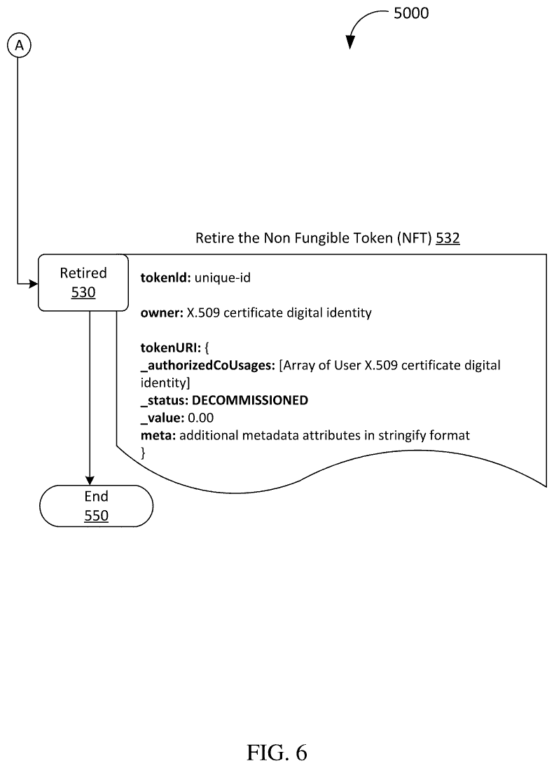

FIG. 6 is a continuation flow diagram of FIG. 5.

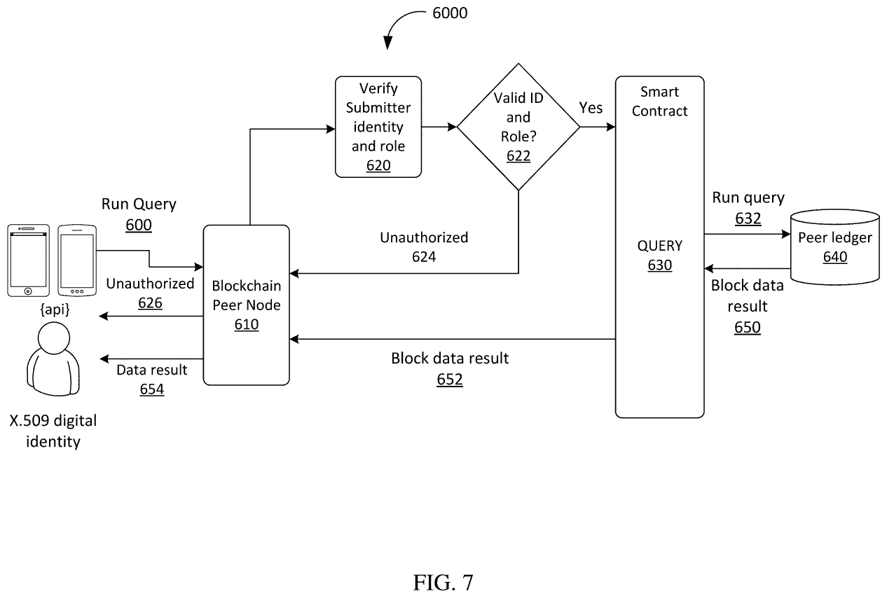

FIG. 7 is a flow diagram of a method 6000 for querying/pulling data out of the blockchain network, in accordance with some embodiments. Accordingly, at (600), the method (6000) may include an actor, represented by his/her X.509 identity certificate or other protocols such as zero-knowledge proof, issuing a run query request to one of many live blockchain peer nodes (610). Further, at (620), the method (6000) may include verifying submitter identity and role. Further, at (622), the method (6000) may include deciding if the ID and role are valid. The first order of business is to verify the submitter's identity and the role and make a decision if the ID and role are valid. If invalid or does not have the necessary permission, at (624), the method (6000) may include the blockchain triggering an unauthorized, which is sent to the submitter request with such unauthorized (626) message. If the blockchain evaluates to a valid ID and role, at (630), the method (6000) may include forwarding a request is forwarded to the smart contract installed on the blockchain peer node to run a query (632) to pull an associated block record from a peer ledger (640). Further, a block data result (650) is retrieved from the peer ledger (640), and the network sends that response to the blockchain peer node, which ultimately relays it to the requester device. Further, a block data result (652) is transferred from the query (630) to the blockchain peer nodes (610). Further, a block data result (654) is transferred from the blockchain peer nodes (610).

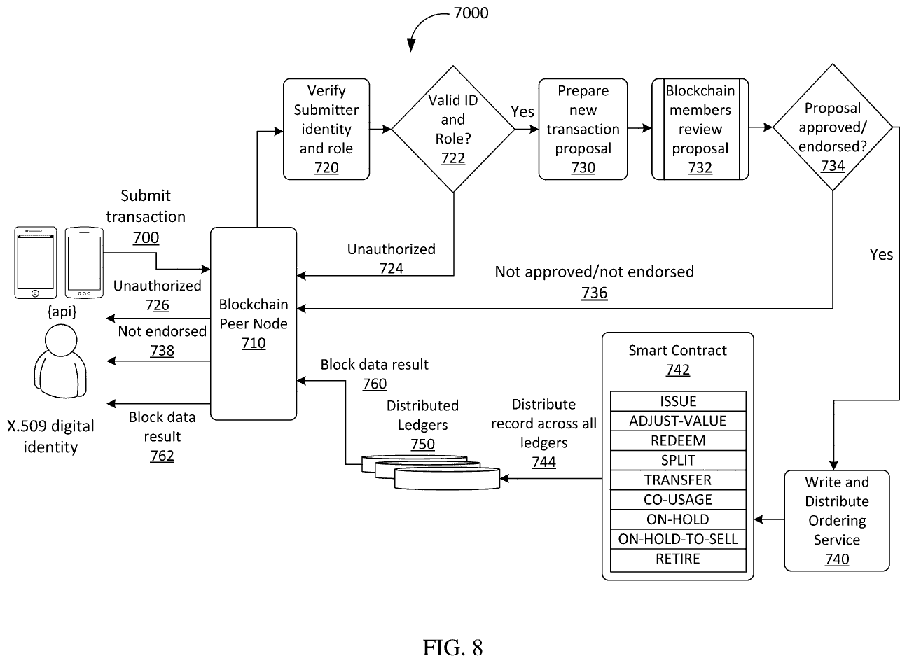

FIG. 8 is a flow diagram of a method 7000 for facilitating submitting a transaction and ultimately writing a record onto the blockchain, in accordance with some embodiments. Accordingly, an actor, represented by his/her X.509 identity certificate or similar identity protocols, at (700), the method (7000) may include submitting a transaction request to one of many live blockchain peer nodes (710). Further, at (720), the method (7000) may include verifying submitter identity and role. Further, at (722), the method (7000) may include deciding if the ID and role are valid. Further, as with all transactions, the first order of business is to verify the submitter's identity and role (720) and the network makes a decision if such ID and role are valid. If invalid or not having the necessary permission, at (724), the method (7000) may include the blockchain triggering an unauthorized (724), which is sent to the submitter request with such unauthorized (726) message. If the blockchain evaluates to a valid ID and role, at (730), the method (7000) may include the network preparing a new transaction proposal. Further, at (732), the method (7000) may include reviewing the transaction proposal (or proposal) by the blockchain member according to the network policy. Further, at (734), the method (7000) may include checking the proposal is approved/endorsed. If the proposal decision evaluates to a no, the network issues a not approved / not endorsed (736) message, which is then sent to the originating blockchain peer node (710) and relayed to the submitter with a not endorsed (738) message. If the proposal decision (734) recommends proceeding or evaluates to a yes, at (740), the method (7000) may include the network sending the endorsed message to the network ordering service to write and distribute. A smart contract (742) installed on a peer node is responsible for writing data with correct transaction logic on the block. The ordering service executes the smart contract (742) across all peer nodes, which effectively distributes that record across all ledgers (744), and hence the distributed ledgers (750). Optionally, at (760), the method (7000) may include returning a newly created block data result to the initiating actor and the user may view the block data result via his/her device. Further, a block data result (762) is transferred from the blockchain peer nodes (710).

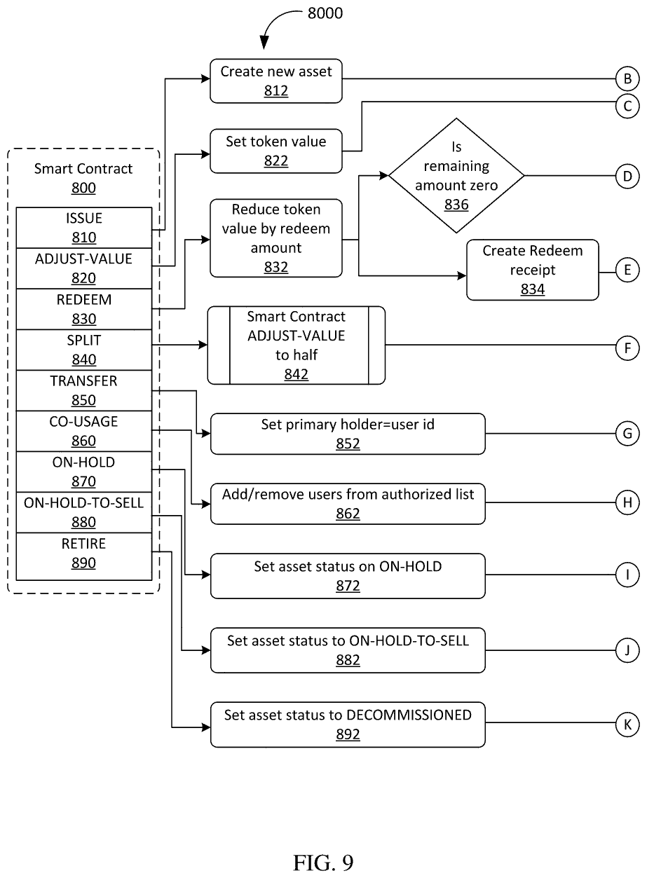

FIG. 9 is a flow diagram of a method (8000) for facilitating querying and writing block records at blockchain peer nodes using a smart contract (800), in accordance with some embodiments. Accordingly, the method (8000) may include the stored-value card platform employing a series of transactions as follows. Further, an ISSUE (810) transaction is responsible for minting a new token (812) record and registering to a ledger or distributed ledger (802). Further, an adjust-value (820) transaction is responsible for adjusting a token to a new value (822) and registering that asset block to the ledger (802). Further, at (832), the method (8000) may include a REDEEM (830) transaction adjusting/reducing a token value by the redeem amount, and at (834), creating a redeem receipt. Further, at (836), the method (8000) may include the REDEEM (830) transaction checking if the remaining asset value is zero or fully consumed, and if so will internally invoke a smart contract with s RETIRE (838) transaction. All resulting new and updated records may be registered onto the ledger (802). Further, a SPLIT (840) transaction may invoke a series of internal smart contract transactions. Further, at (842), the method (8000) may include the SPLIT (840) transaction invoking an ADJUST-VALUE smart contract to set a new reduced value to the originating token. Next in the sequence is invoking a smart contract ISSUE (844) transaction to create a new asset or to mint a token record with an offset value of the originating token. All resulting new and updated records may be registered onto the ledger (802). Further, at (852), the method (8000) may include a TRANSFER (850) transaction replacing the primary holder with a supplied user ID (852). The network may also create a shadow snapshot record with the prior primary holder before the change for the purpose of easy audit if/when necessary. All resulting new and updated records may be registered onto the ledger (802). Further, at (862), the method (8000) may include a CO-USAGE (860) updating the authorized co-usage field with a list of approved users' identities. The network may also create a shadow snapshot record with the prior primary holder before the change for the purpose of easy audit if/when necessary. All resulting new and updated records may be registered onto the ledger (802). Further, at (872), the method (8000) may include an ON-HOLD (870) transaction updating asset status to ON-HOLD for a general-purpose, and registering that asset status onto the ledger (802). Further, at (882), the method (8000) may include an ON-HOLD-TO-SELL (880) transaction updating asset status to ON-HOLD-TO-SELL for the purpose of selling or exchanging in the marketplace and registering that status onto the ledger (802). Further, at (892), the method (8000) may include a retire (890) transaction updating asset status to DECOMMISSIONED which terminates the lifecycle of this asset, and registering that asset status onto the ledger (802).

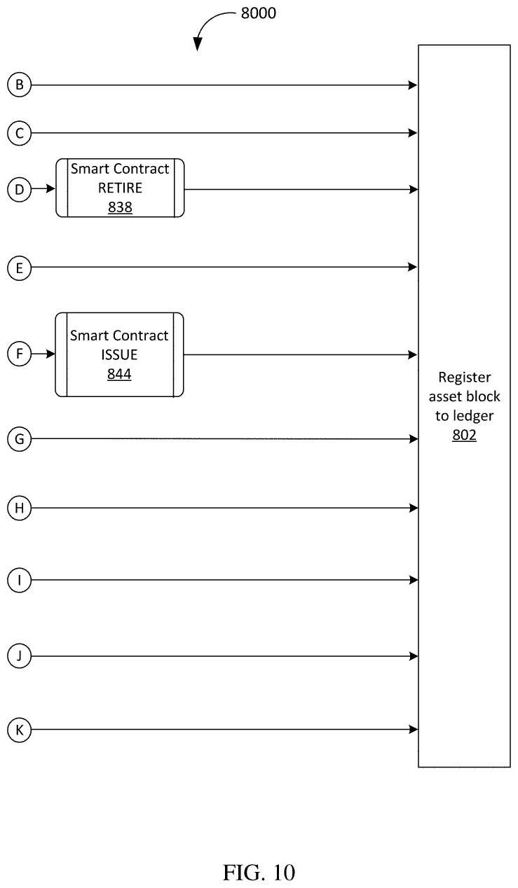

FIG. 10 is a continuation flow diagram of the method 8000 for facilitating writing block records at blockchain peer nodes using the smart contract, in accordance with some embodiments.

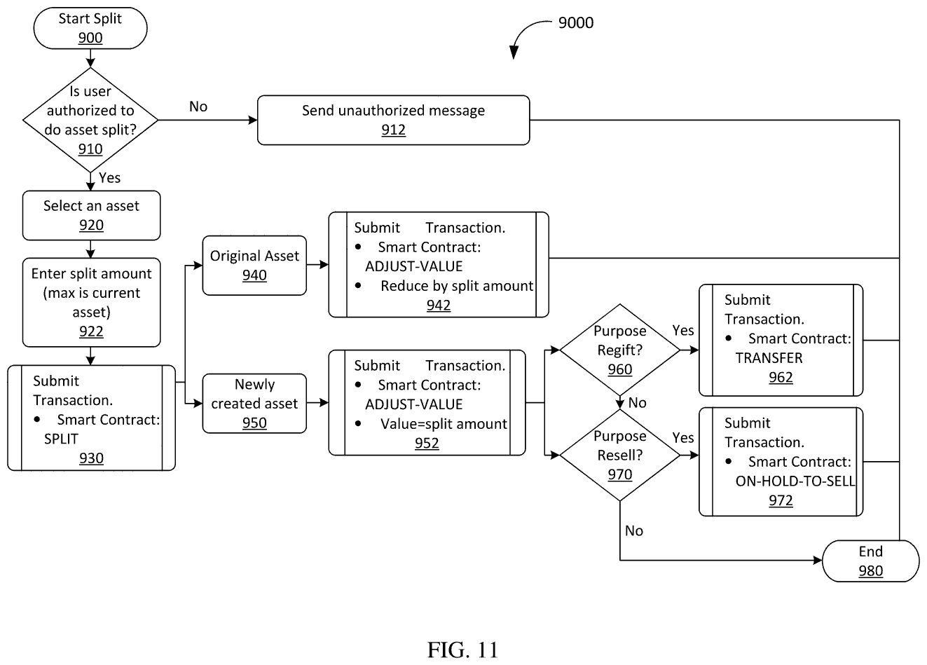

FIG. 11 is a flow diagram of a method (9000) for splitting an asset into a smaller value, with an option of regifting or reselling, in accordance with some embodiments. Accordingly, the method (9000) may include starting step (900) with a series of upfront check as follow. Further, at (910), the method (9000) may include verifying whether the submitter has the necessary permission to do an asset split, which such permission is typically given only to a current asset/token owner. Further, if this check fails, the system rejects the request, sends out a not-authorized error (912), and leads to an ending step (980). If authorized, at (920), the method (9000) may include the submitter confirming the asset (920) to split. Further, at (922), the method (9000) may include the submitter entering a desired split amount. Further, at (930), the method (9000) may include the network submitting a smart contract SPLIT transaction. For an original asset (940), at (942), the network submits an internal request with a smart contract ADJUST-VALUE transaction to reduce the asset amount by the split amount. For a newly created asset (950), at (952), the network submits a request with a smart contract ADJUST-VALUE transaction with the split amount. If a split is for Regift (960) purpose, at (962), the network submits another internal request with smart contract TRANSFER. If the split is for Resell (970) purpose, at (972), the network submits another internal request with smart contract ON-HOLD-TO-SELL. Further, after (962), the method (9000) may progress to the ending step (980). Further, after (972), the method (9000) may progress to the ending step (980). Further, if the split is not for reselling purposes, then after (970), the method (9000) may progress to the ending step (980).

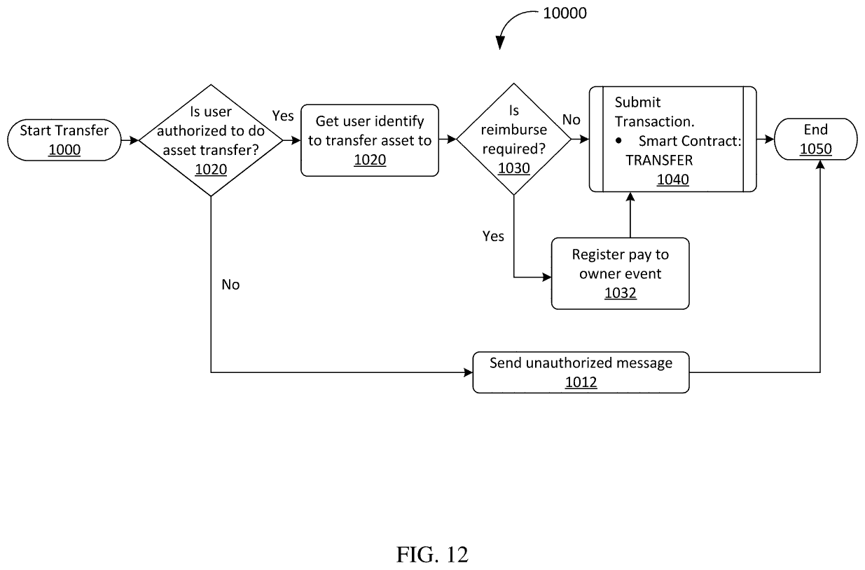

FIG. 12 is a flow diagram of a method (10000) for transferring an asset, in accordance with some embodiments. Accordingly, this provides an option if an actor/current owner wants to transfer his/her asset as an independent action (not part of a split, regift transaction). Further, at (1000), the method (10000) may include starting a transfer. Further, the transfer starts with a series of upfront checks as follows. Further, at (1010), the method (10000) may include verifying whether the submitter has the necessary permission to do an asset transfer, which such permission is typically given only to a current asset/token owner. If this check fails, the system rejects the request and at (1012), the method (10000) may include sending out a not-authorized error message and proceeds to an ending step (1050). If checks yield to authorize, at (1020), the method (10000) may include the submitter providing user identity to transfer an asset to. Further, at (1030), the method (10000) may include checking if pay reimbursement from the new owner to the submitter is required. If required, at (1032), the method (10000) may include the systems registering to pay to the owner event. Further, the network submits an internal request with a smart contract TRANSFER transaction (1040).

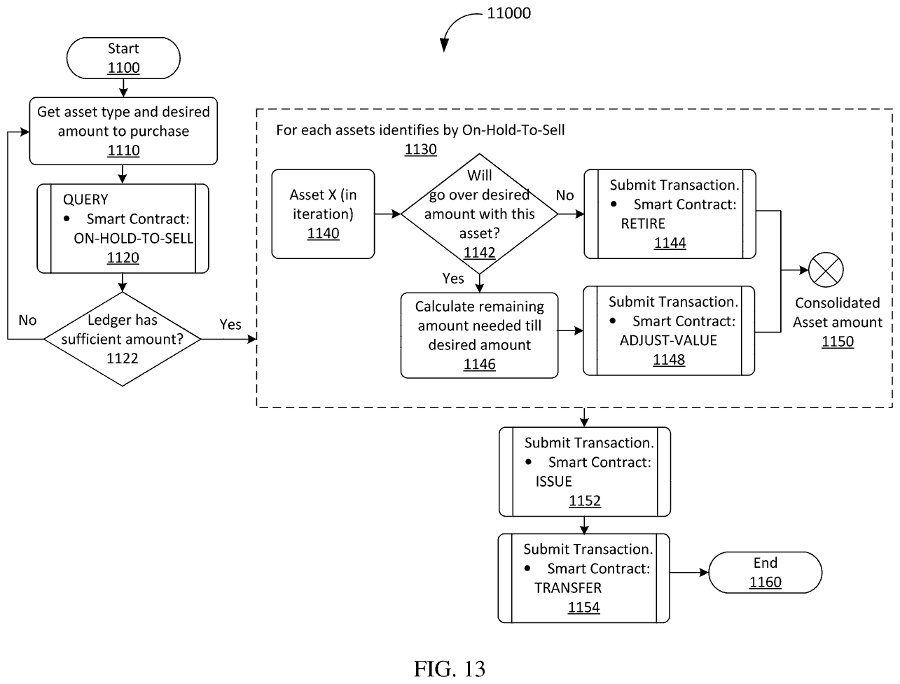

FIG. 13 is a flow diagram of a method (11000) for facilitating allowing customers to easily buy a new asset sourced from previously owned cards, in accordance with some embodiments. Accordingly, the previously owned cards may have either been unused or partially used by one or more owners. Internally it deploys a series of previously discussed transactions in an orchestrated sequence within the network. Further, at (1100), the method (11000) may include a starting step. Further, at (1110), the method (11000) may include a buyer entering asset type and amount to purchase. Further, at (1120), the method (11000) may include a smart contract ON-HOLD-TO-SELL query retrieving all assets of the desired type with an internal request. Further, at (1122), the method (11000) may include checking if the ledger has a sufficient amount to give per buyer's desire. If the balance is insufficient, the system may prompt users to enter a lesser amount and the method (11000) may proceed to (1110). If the ledger with asset ON-HOLD-TO-SELL has sufficient balance for the asset type, at (1130), the method (11000) may include launching a series of transactions. For each asset identified to be sold (1140), at (1142), the method (11000) may include checking if adding this asset may surpass the desired buy amount. If no (not going over), at (1144), the method (11000) may include launching an internal request with z smart contract RETIRE transaction. If it goes over the desired amount, at (1146), the method (11000) may include calculating the remaining amount needed till a desired amount. Further, at (1148), the method (11000) may include submitting an internal request with a smart contract ADJUST-VALUE transaction. As assets with ON-HOLD-TO-SELL status are retired and/or adjusted in value resulting in systems orchestration, the system credits an internal account to temporarily accumulate asset value (series of transactions). When the series of transactions orchestrated by the network concludes, at (1150), the method (11000) may include debiting parked consolidated amounts. Further, at (1152), the method (11000) may include submitting an internal request with a smart contract ISSUE transaction. Further, at (1154), the method (11000) may include launching another internal request with a smart contract TRANSFER transaction (1154) for the buyer. When all concludes, at (1160), the method (11000) may include ending the series of transactions.

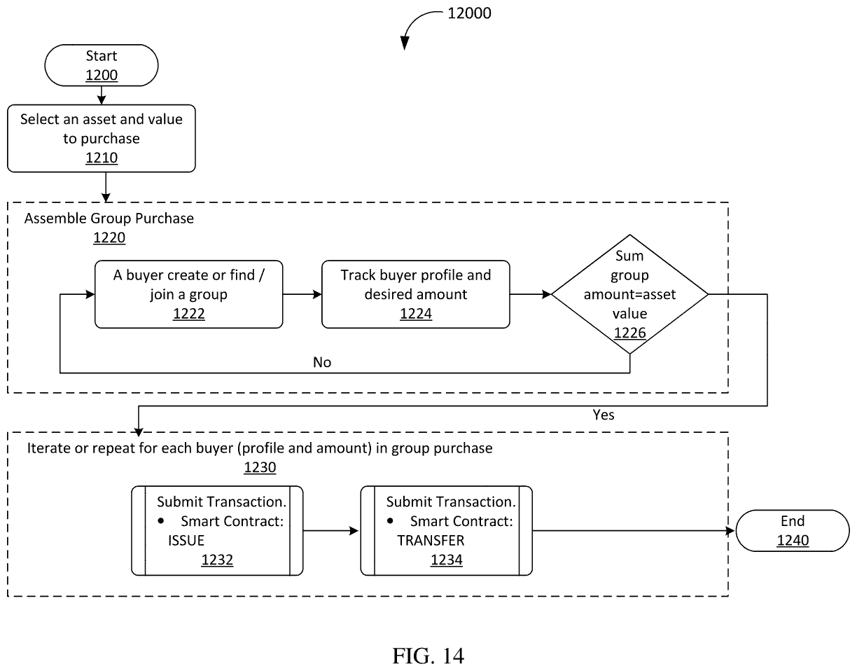

FIG. 14 is a flow diagram of a method (12000) for facilitating group purchases request and asset issuance to each buyer within the purchase group, in accordance with some embodiments. Accordingly, at (1200), the method (12000) may include a starting step. Further, at (1210), the method (12000) may include a consumer or a buyer selecting an asset and publishing an amount value to purchase from a marketplace. If a group purchase is sought, at (1222), the method (12000) may include a consumer activating an assemble group purchase (1220) process by either creating/finding/joining a purchasing group, submitting the buyer's profile, and his/her desired purchase amount. Further, at (1224), the method (12000) may include tracking buyer profile and desired amount. Further, at (1226), the method (12000) may include a system tallying the group submission amount and waiting for the next buyer(s) if the summed group amount is below the published or asked asset value. If the summed group purchase amount and asset value both reach an equilibrium, the system iterate for asset issues. Further, if the sum group amount is not equivalent to asset value, then after (1226), the method (12000) may proceed to (1222). For each buyer within the group purchase, at (1232), the method (12000) may include a smart contract issuing an asset with the desired amount and at (1234), internally transferring that asset to each buyer. Further, at (1230), the method (12000) may include the system iterating until all buyers within the group are completed. Further, at (1240), the method (12000) may include an ending step.

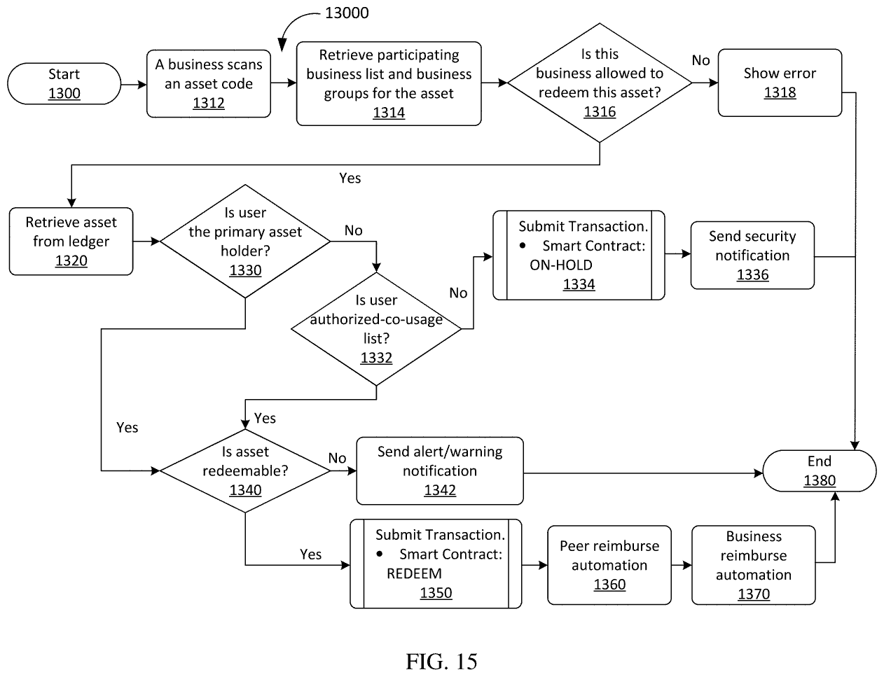

FIG. 15 is a flow diagram of a method (13000) for facilitating redeeming an asset, in accordance with some embodiments. Accordingly, at (1300), the method (13000) starts with upfront business redeems eligibility checks. The first set of checks is focused on the business. Further, at (1312), the method (13000) may include a business operator scanning an asset code to redeem. Further, at (1314), the method (13000) may include a system retrieving participating business lists and groups that may be allowed to redeem this asset. This is necessary as businesses can organize as a group where a stored-value card (or a prepaid access card) can be redeemed within the issuing business group and also by other businesses within the platform. Further, at (1316), the method (13000) may include checking for business redeem eligibility. If checks fail/are not eligible, at (1318), the method (13000) may include prompting an error message and terminating redeem process to an ending step (1380). Further, the second set of checks is focused on the submitter. Further, at (1320), the method (13000) may include retrieving the previously scanned asset from the ledger. Further, at (1330), the method (13000) may include verifying if the submitter is the asset or token owner. If the first check fails, at (1332), the method (13000) may include proceeding with a secondary check to verify the submitter is listed as authorized-co-usage. If both checks fail, at (1334), the method (13000) may include a system launching an internal smart contract ON-HOLD transaction. Further, at (1336), the method (13000) may include sending out a security notification. If checks are good and the submitter has the right to redeem the asset, the system continues with the next set of checks which is focused on the asset itself. Further, at (1340), the method (13000) may include the system verifying if the asset is redeemable. If not redeemable, at (1342), the method (13000) may include the system sending out an alert or warning notification which then allows for further troubleshooting and resolution. If all checks pass, the system allows the asset to be redeemed. Further, at (1350), the method (13000) may include the network launching a smart contract with REDEEM transaction. Further, at (1360), the method (13000) may include the system registering a peer reimburse automation (1360) if redeemed by authorized-co-usage. Further, at (1370), the method (13000) may include executing business-to-business reimbursement if redeemed by other participating businesses within the group and platform. This enables collaborative consumption and trade across businesses and social consumer peers. Further, after (1342), the method (13000) may proceed to (1380). Further, after (1370), the method (13000) may proceed to (1380).

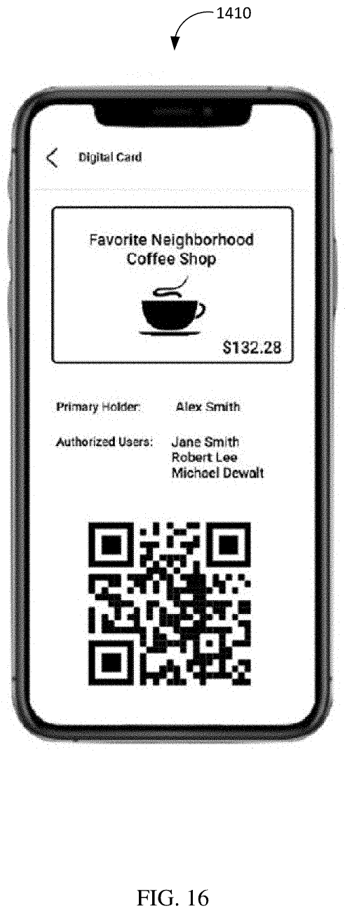

FIG. 16 is a screenshot of a stored-value card sample user interface (1410) being displayed on a mobile phone, in accordance with some embodiments. Accordingly, the stored-value card sample may include a gift card sample.

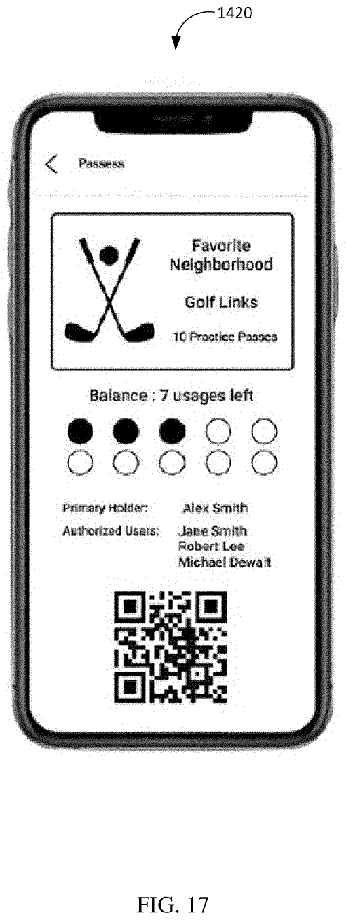

FIG. 17 is a screenshot of a stored-value card sample user interface (1420) being displayed on a mobile phone, in accordance with some embodiments. Accordingly, the stored-value card sample may include passes mockup samples.

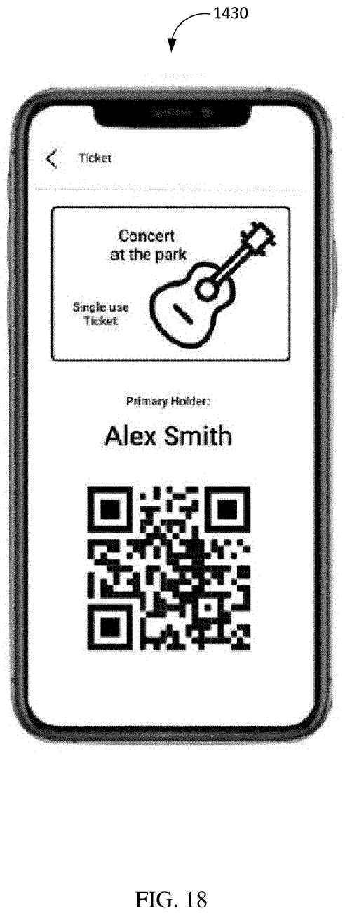

FIG. 18 is a screenshot of a stored-value card sample user interface (1430) being displayed on a mobile phone, in accordance with some embodiments. Accordingly, the stored-value card sample may include a ticket mockup sample.

In further embodiments, a method for facilitating managing stored-value cards transactions and collaborative trading across businesses and social peers using blockchain is disclosed. Accordingly, the method may include receiving, using a communication device, user data from at least one user device associated with at least one user. Further, the at least one user may include an individual that may want to manage stored value cards and trade collaboratively across business and social peers. Further, the at least one user device may include a laptop, a smartphone, a tablet, a personal computer, and so on. Further, the user data may be associated with the at least one user. Further, the user data may include a name, an address, a contact number, a website, an email address, etc.

Further, the method may include processing, using a processing device, the user data to generate a user account. Further, the user account may include a user profile. Further, the user profile may be associated with a password and a login id.

Further, the method may include receiving, using the communication device, a purchase request and payment corresponding to at least one stored value card from the at least one user device. Further, the purchase request may indicate that the at least one user may want to purchase the at least one stored value card. Further, the payment may be associated with an amount of the at least one stored value card.

Further, the method may include generating, using the processing device, a stored value card indication based on the receiving. Further, the stored value card indication may correspond to the successful purchase of the at least one stored value card.

Further, the method may include associating, using the processing device, the at least one stored value card to the user profile based on the stored value card indication.

Further, the method may include receiving, using the communication device, a trading request corresponding to the at least one stored value card from the at least one user device. Further, the trading request may indicate that the at least one user may want to one of issue, sell, and buy the at least one stored value card. Further, the trading request may include second user details of at least one second user with whom the at least one user may want to trade the at least one stored value card. Further, the at least one second user may include an individual, an institution, and an organization. Further, the second user details may include user profile ID, name, email address, etc. Further, the trading request may include a trading amount associated with the at least one stored value card. Further, the trading amount may be equal or less than the amount of the stored value card.

Further, the method may include verifying, using the processing device, the second user details to generate a verifier corresponding to the at least one second user. Further, the verifier may correspond to the authenticity of the second user details. Further, the verifier may reduce the risk of fraudulent transactions (or trading) of stored value cards.

Further, the method may include transmitting, using the communication device, the trading request corresponding to the at least one stored value card to at least one second user device based on the verifier. Further, the at least one second user device may include a laptop, a smartphone, a tablet, a personal computer, and so on.

Further, the method may include receiving, using the communication device, a notification corresponding to the trading request from the at least one second user device. Further, the notification may indicate that the at least one second user may want to trade the at least one stored value card. Further, in an instance, for the at least one second user to buy the at least one stored value card, the notification may include a payment corresponding to the at least one stored value card.

Further, the method may include generating, using the processing device, a transaction confirmation based on the notification. Further, the transaction confirmation may indicate the successful trading of the at least one stored value card.

Further, the method may include transmitting, using the communication device, the transaction confirmation to the at least one user device and the at least one second user device.

Further, the method may include storing, using a storage device, the transaction confirmation, the notification, the trading request, the user data, the stored value card indication, and the purchase request in a distributed ledger.

In further embodiments, a system for facilitating managing stored-value cards transactions and collaborative trading across businesses and social peers using blockchain is disclosed. Accordingly, the system may include a communication device configured for receiving user data from at least one user device associated with at least one user. Further, the at least one user may include an individual that may want to manage stored value cards and trade collaboratively across business and social peers. Further, the at least one user device may include a laptop, a smartphone, a tablet, a personal computer, and so on. Further, the user data may be associated with the at least one user. Further, the user data may include a name, an address, a contact number, a website, an email address, etc. Further, the communication device may be configured for receiving a purchase request and payment corresponding to at least one stored value card from the at least one user device. Further, the purchase request may indicate that the at least one user may want to purchase the at least one stored value card. Further, the payment may be associated with an amount of the at least one stored value card. Further, the communication device may be configured for receiving a trading request corresponding to the at least one stored value card from the at least one user device. Further, the trading request may indicate that the at least one user may want to one of issue, sell, and buy the at least one stored value card. Further, the trading request may include second user details of at least one second user with whom the at least one user may want to trade the at least one stored value card. Further, the at least one second user may include an individual, an institution, and an organization. Further, the second user details may include user profile ID, name, email address, etc. Further, the trading request may include a trading amount associated with the at least one stored value card. Further, the trading amount may be equal or less than the amount of the stored value card. Further, the communication device may be configured for transmitting the trading request corresponding to the at least one stored value card to at least one second user device based on a verifier. Further, the at least one second user device may include a laptop, a smartphone, a tablet, a personal computer, and so on. Further, the communication device may be configured for receiving a notification corresponding to the trading request from the at least one second user device. Further, the notification may indicate that the at least one second user may want to trade the at least one stored value card. Further, in an instance, for the at least one second user to buy the at least one stored value card, the notification may include a payment corresponding to the at least one stored value card. Further, the communication device may be configured for transmitting a transaction confirmation to the at least one user device and the at least one second user device.

Further, the system may include a processing device configured for processing the user data to generate a user account. Further, the user account may include a user profile. Further, the user profile may be associated with a password and a login id. Further, the processing device may be configured for generating a stored value card indication based on the receiving. Further, the stored value card indication may correspond to the successful purchase of the at least one stored value card. Further, the processing device may be configured for associating the at least one stored value card to the user profile based on the stored value card indication. Further, the processing device may be configured for verifying the second user details to generate the verifier corresponding to the at least one second user. Further, the verifier may correspond to the authenticity of the second user details. Further, the verifier may reduce the risk of fraudulent transactions (or trading) of stored value cards. Further, the processing device may be configured for generating the transaction confirmation based on the notification. Further, the transaction confirmation may indicate the successful trading of the at least one stored value card.

Further, the system may include a storage device configured for storing the transaction confirmation, the notification, the trading request, the user data, the stored value card indication, and the purchase request in a distributed ledger.

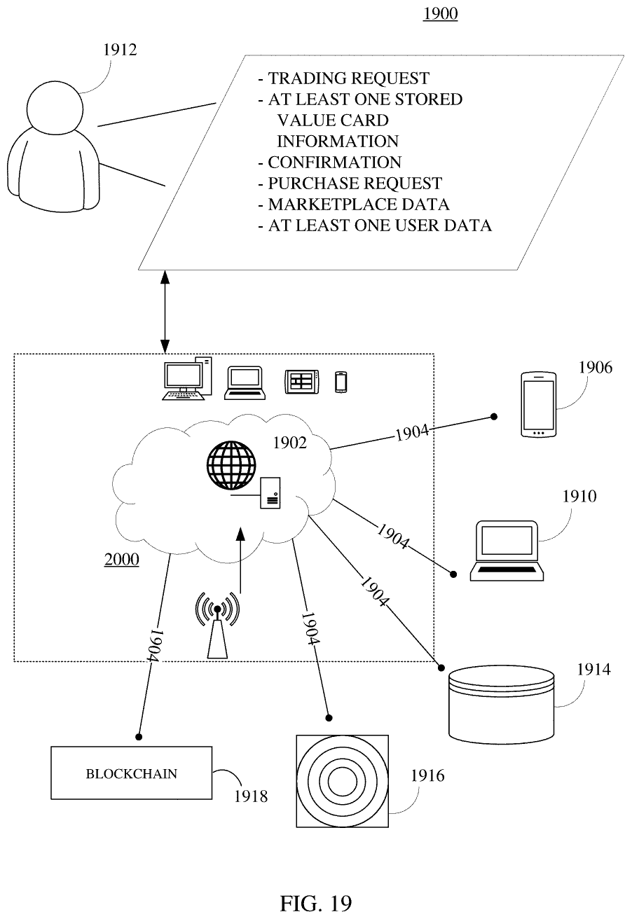

FIG. 19 is an illustration of an online platform 1900 consistent with various embodiments of the present disclosure. By way of non-limiting example, the online platform 1900 to enable facilitating trading the stored value card using blockchain may be hosted on a server 1902, such as, for example, a cloud computing service. The server 1902 may communicate with other network entities, such as, for example, a mobile device 1906 (such as a smartphone, a laptop, a tablet computer, etc.), other electronic devices 1910 (such as desktop computers, server computers, etc.), databases 1914, sensors 1916, and a blockchain 1918 (such as a distributed ledger) over a communication network 1904, such as, but not limited to, the Internet. Further, users of the online platform 1900 may include relevant parties such as, but not limited to, end-users, administrators, service providers, service consumers and so on. Accordingly, in some instances, electronic devices operated by the one or more relevant parties may be in communication with the platform.

A user 1912, such as the one or more relevant parties, may access online platform 1900 through a web-based software application or browser. The web-based software application may be embodied as, for example, but not be limited to, a website, a web application, a desktop application, and a mobile application compatible with a computing device 2000.

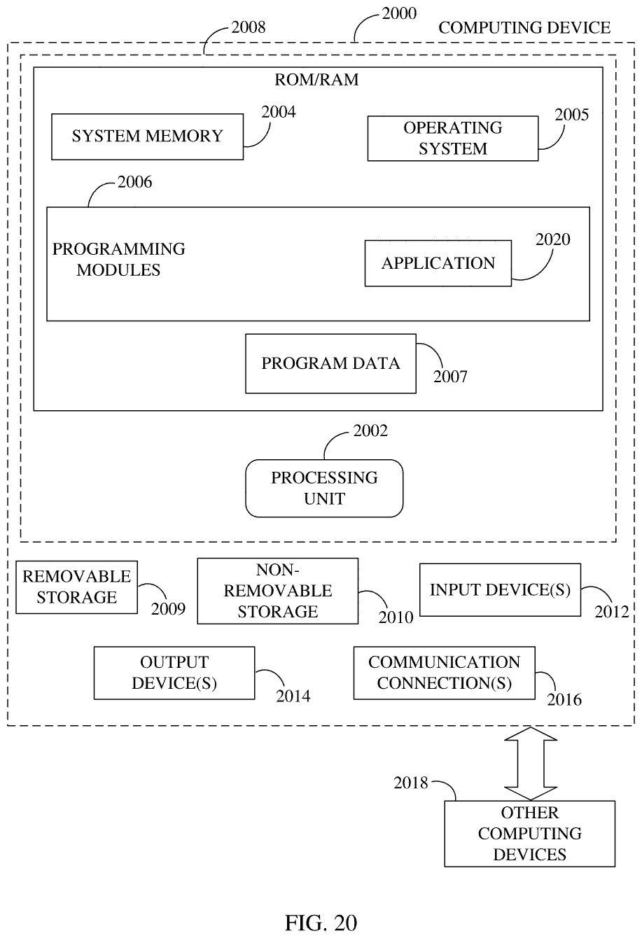

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g., random-access memory (RAM)), non-volatile (e.g., read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

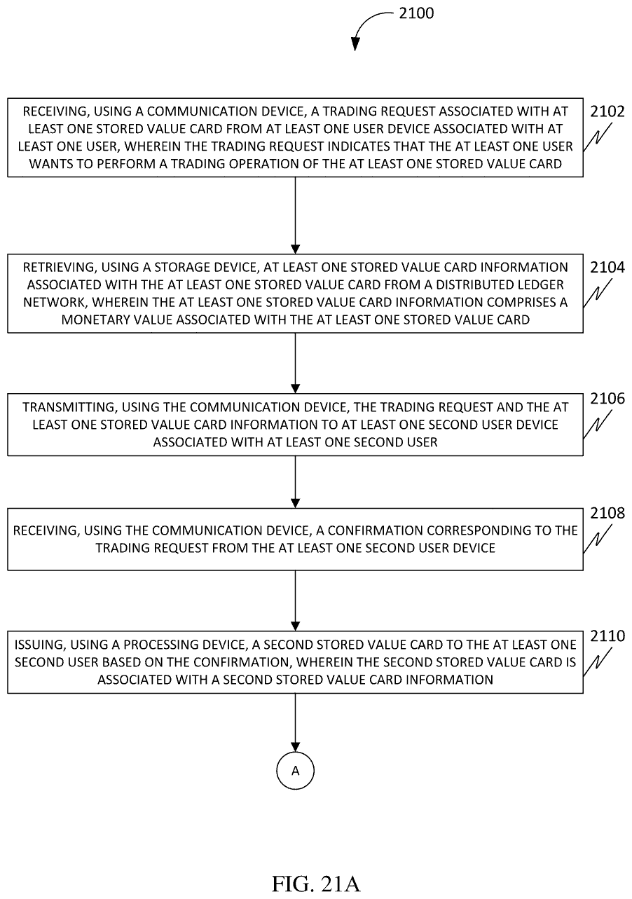

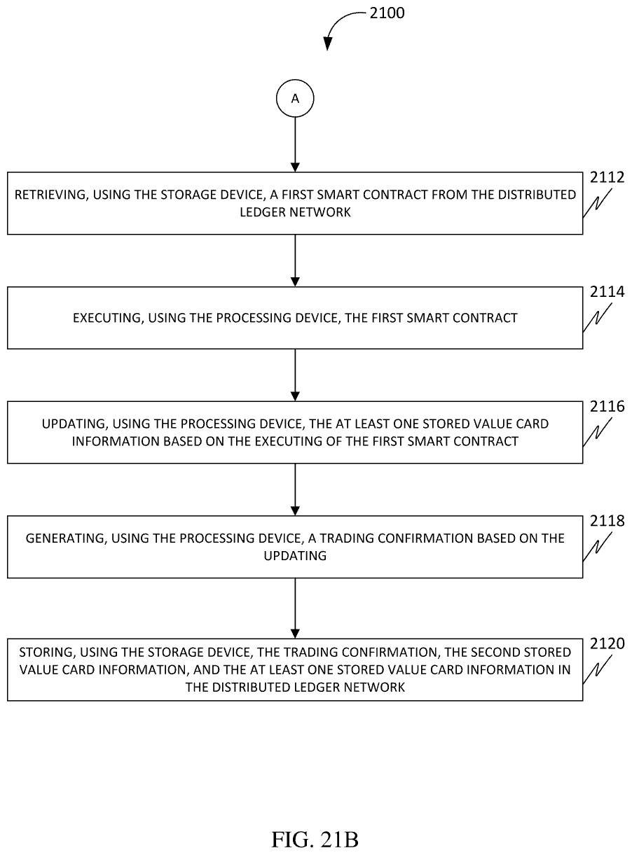

FIG. 21A and FIG. 21B illustrate a flowchart of a method 2100 of facilitating trading a stored value card using blockchain, in accordance with some embodiments. Accordingly, the method 2100 may include a step 2102 of receiving, using a communication device 2902, a trading request associated with at least one stored value card from at least one user device (such as one or more user devices 3002-3004) associated with at least one user, wherein the trading request indicates that the at least one user wants to perform a trading operation of the at least one stored value card. Further, the at least one stored value card may include gift cards/vouchers, tickets, passes, and other types of cards or vouchers. Further, the at least one stored value card may include at least one prepaid access card.

Further, the method 2100 may include a step 2104 of retrieving, using a storage device 2904, at least one stored value card information associated with the at least one stored value card from a distributed ledger network (or a distributed ledger), wherein the at least one stored value card information comprises a monetary value associated with the at least one stored value card. Further, the at least one stored value card information comprises owner details, usage permission details, usage terms and conditions, etc.

Further, the method 2100 may include a step 2106 of transmitting, using the communication device 2902, the trading request and the at least one stored value card information to at least one second user device (such as one or more second user devices 3006-3008) associated with at least one second user.

Further, the method 2100 may include a step 2108 of receiving, using the communication device 2902, a confirmation corresponding to the trading request from the at least one second user device.

Further, the method 2100 may include a step 2110 of issuing, using a processing device 2906, a second stored value card to the at least one second user based on the confirmation, wherein the second stored value card is associated with a second stored value card information. Further, in an embodiment, the second stored value card may include a second prepaid access card.

Further, the method 2100 may include a step 2112 of retrieving, using the storage device 2904, a first smart contract from the distributed ledger network.

Further, the method 2100 may include a step 2114 of executing, using the processing device 2906, the first smart contract.

Further, the method 2100 may include a step 2116 of updating, using the processing device 2906, the at least one stored value card information based on the executing of the first smart contract.

Further, the method 2100 may include a step 2118 of generating, using the processing device 2906, a trading confirmation based on the updating.

Further, the method 2100 may include a step 2120 of storing, using the storage device 2904, the trading confirmation, the second stored value card information, and the at least one stored value card information in the distributed ledger network.

Further, in some embodiments, the method 2100 may include transmitting, using the communication device 2902, the trading confirmation to the at least one user device and the at least one second user device. Further, the trading confirmation may indicate successful trading of the at least one stored value card.

In some embodiments, a monetary value of the second stored value card may be equivalent to at least a portion of the monetary value of the one or more stored value cards.

In some embodiments, the trading operation may include one or more of issuance, adjustment, purchasing, splitting, selling, transferring, co-using, on-holding, and consolidating the one or more stored value cards between the one or more users and the one or more second users.

Further, in some embodiments, the method 2100 may include a step of receiving, using the communication device 2902, a lost request from the at least one user device, wherein the lost request indicates that a lost card of the at least one stored value card is lost by the at least one user, wherein the lost request comprises lost card information associated with the lost card. Further, the lost card information may include card recovery information that may include name,

Identification number, email address, etc. Further, the method 2100 may include a step of retrieving, using the storage device 2904, a third smart contract and a stored card information corresponding to the lost card from the distributed ledger network based on the receiving of the lost request, wherein the at least one stored value card information comprises the stored card information.

Further, the method 2100 may include a step of executing, using the processing device 2906, the third smart contract.

Further, the method 2100 may include a step of analyzing, using the processing device 2906, the at least one stored value card information and the lost card information based on the executing of the third smart contract.

Further, the method 2100 may include a step of verifying, using the processing device 2906, ownership of the lost card based on the analyzing of the at least one stored value card information and the lost card information.

Further, the method 2100 may include a step of issuing, using the processing device 2906, a replacement card corresponding to the lost card based on the verifying, wherein the replacement card is associated with a replacement value card information

Further, the method 2100 may include a step of storing, using the storage device 2904, the replacement value card information in the distributed ledger network, wherein the updating of the at least one stored value card information is further based on the issuing.

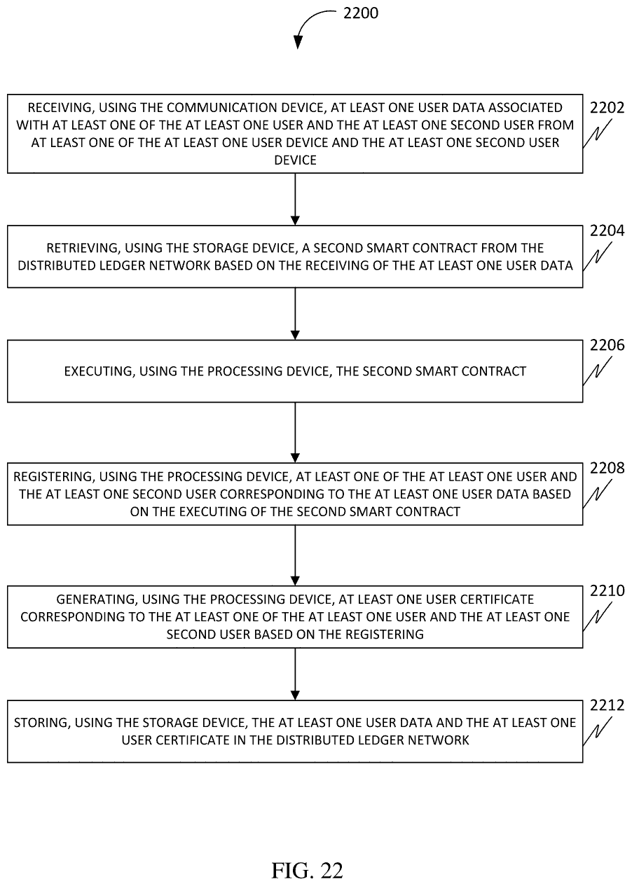

FIG. 22 illustrates a flowchart of a method 2200 of facilitating trading a stored value card using blockchain, in accordance with some embodiments.

Further, the method 2200 may include a step 2202 of receiving, using the communication device 2902, at least one user data associated with at least one of the at least one user and the at least one second user from at least one of the at least one user device and the at least one second user device. Further, the at least one user data may include a username, user ID proof, a user age, a user address, a user email address, etc.

Further, the method 2200 may include a step 2204 of retrieving, using the storage device 2904, a second smart contract from the distributed ledger network based on the receiving of the at least one user data.

Further, the method 2200 may include a step 2206 of executing, using the processing device 2906, the second smart contract.

Further, the method 2200 may include a step 2208 of registering, using the processing device 2906, at least one of the at least one user and the at least one second user corresponding to the at least one user data based on the executing of the second smart contract.

Further, the method 2200 may include a step 2210 of generating, using the processing device 2906, at least one user certificate corresponding to the at least one of the at least one user and the at least one second user based on the registering.

Further, the method 2200 may include a step 2212 of storing, using the storage device 2904, the at least one user data and the at least one user certificate in the distributed ledger network.

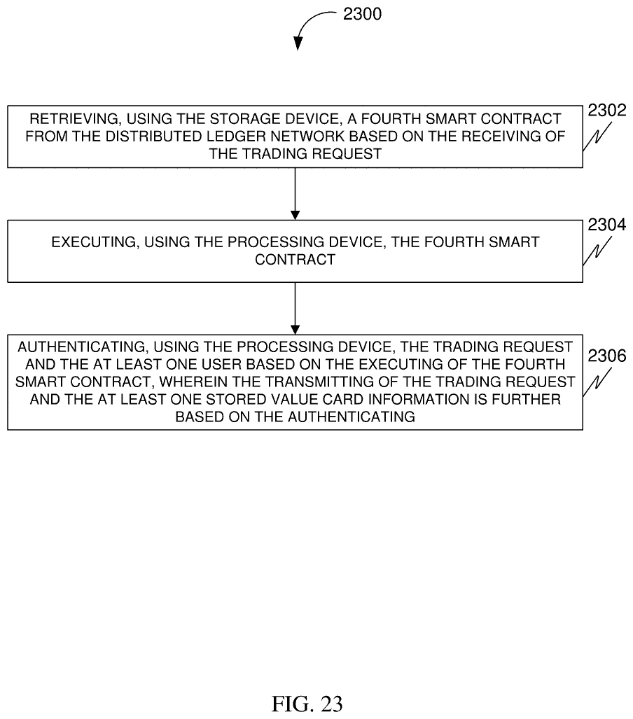

FIG. 23 illustrates a flowchart of a method 2300 of facilitating trading a stored value card using blockchain, in accordance with some embodiments. Further, the method 2300 may include a step 2302 of retrieving, using the storage device 2904, a fourth smart contract from the distributed ledger network based on the receiving of the trading request. Further, the method 2300 may include a step 2304 of executing, using the processing device 2906, the fourth smart contract. Further, the method 2300 may include a step 2306 of authenticating, using the processing device 2906, the trading request and the at least one user based on the executing of the fourth smart contract, wherein the transmitting of the trading request and the at least one stored value card information may be based on the authenticating.

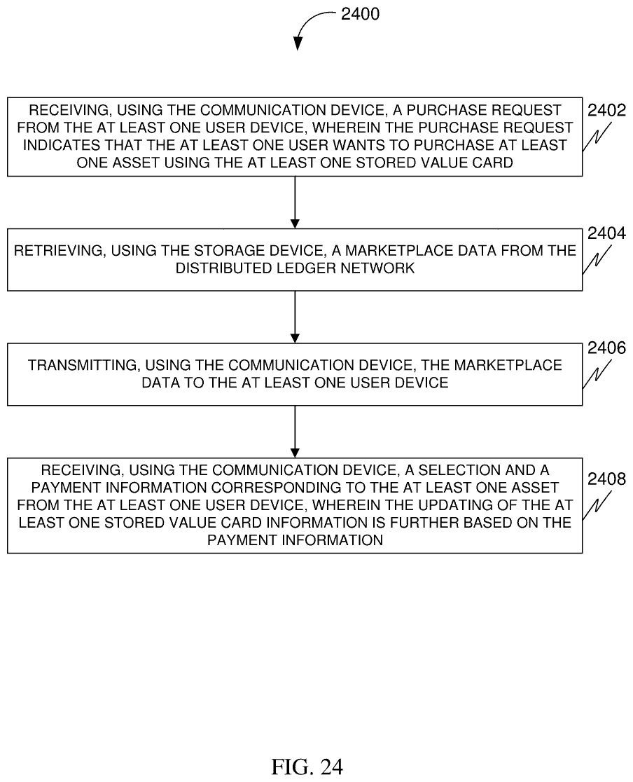

FIG. 24 illustrates a flowchart of a method 2400 of facilitating trading a stored value card using blockchain, in accordance with some embodiments. Further, the method 2400 may include a step 2402 of receiving, using the communication device 2902, a purchase request from the at least one user device, wherein the purchase request indicates that the at least one user wants to purchase at least one asset using the at least one stored value card.

Further, the method 2400 may include a step 2404 of retrieving, using the storage device 2904, a marketplace data from the distributed ledger network.

Further, the method 2400 may include a step 2406 of transmitting, using the communication device 2902, the marketplace data to the at least one user device.

Further, the method 2400 may include a step 2408 of receiving, using the communication device 2902, a selection and a payment information corresponding to the at least one asset from the at least one user device, wherein the updating of the at least one stored value card information is further based on the payment information.

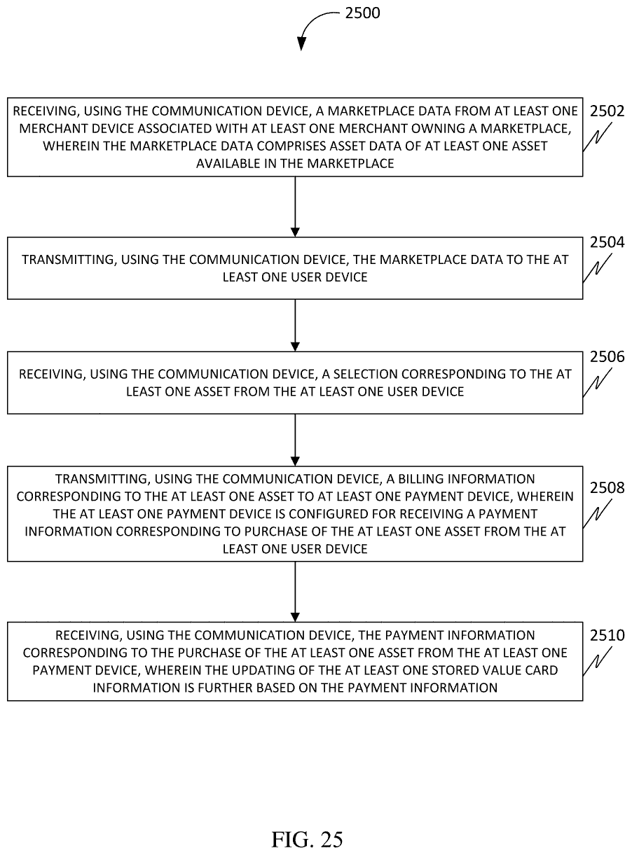

FIG. 25 illustrates a flowchart of a method 2500 of facilitating trading a stored value card using blockchain, in accordance with some embodiments. Further, in some embodiments, the method 2500 may include a step 2502 of receiving, using the communication device 2902, a marketplace data from at least one merchant device (such as one or more merchant devices 3102-3103) associated with at least one merchant owning a marketplace, wherein the marketplace data comprises asset data of at least one asset available in the marketplace.

Further, the method 2500 may include a step 2504 of transmitting, using the communication device 2902, the marketplace data to the at least one user device.

Further, the method 2500 may include a step 2506 of receiving, using the communication device 2902, a selection corresponding to the at least one asset from the at least one user device.

Further, the method 2500 may include a step 2508 of transmitting, using the communication device 2902, a billing information corresponding to the at least one asset to at least one payment device (such as the one or more payment devices 3104-3106), wherein the at least one payment device is configured for receiving a payment information corresponding to purchase of the at least one asset from the at least one user device. Further, the at least one payment device may include an NFC payment machine, card reader, a point-of-sales payment machine, etc.

Further, the method 2500 may include a step 2510 of receiving, using the communication device 2902, the payment information corresponding to the purchase of the at least one asset from the at least one payment device, wherein the updating of the at least one stored value card information is further based on the payment information.

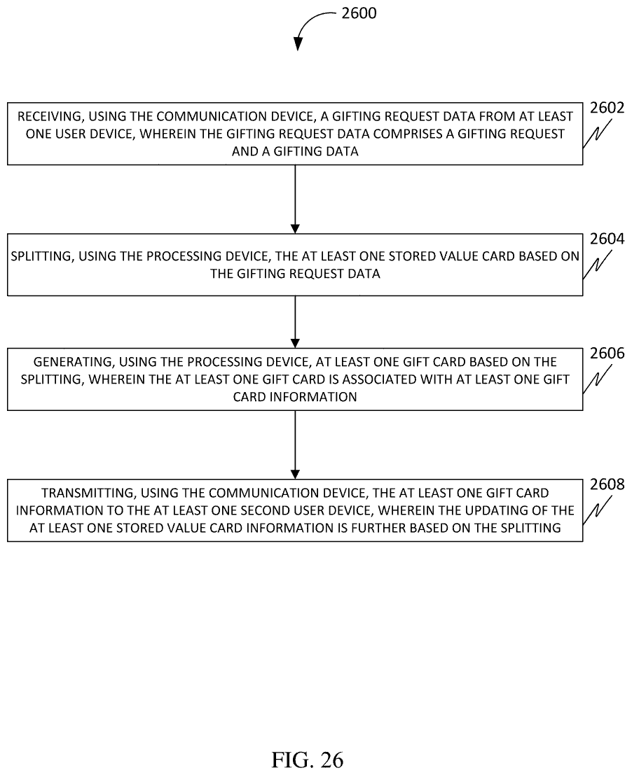

FIG. 26 illustrates a flowchart of a method 2600 of facilitating trading a stored value card using blockchain, in accordance with some embodiments. Accordingly, at 2602, the method 2600 may include receiving, using the communication device, a gifting request data from at least one user device, wherein the gifting request data comprises a gifting request and a gifting data. Further, the gifting data may include details such as name, address, email address, Identity number, etc. of gift receivers (such as the at least one second user). Further, the gifting request may indicate that the at least one user may want to gift a stored value card (or prepaid access card) to the at least one second user. Further, at 2604, the method 2600 may include splitting, using the processing device, the at least one stored value card based on the gifting request data. Further, at 2606, the method 2600 may include generating, using the processing device, at least one gift card based on the splitting, wherein the at least one gift card is associated with at least one gift card information. Further, at 2608, the method 2600 may include transmitting, using the communication device, the at least one gift card information to the at least one second user device, wherein the updating of the at least one stored value card information is further based on the splitting. Further, in an embodiment, the method 2600 may include storing, using the storage device, the at least one gift card information in the distributed ledger network.

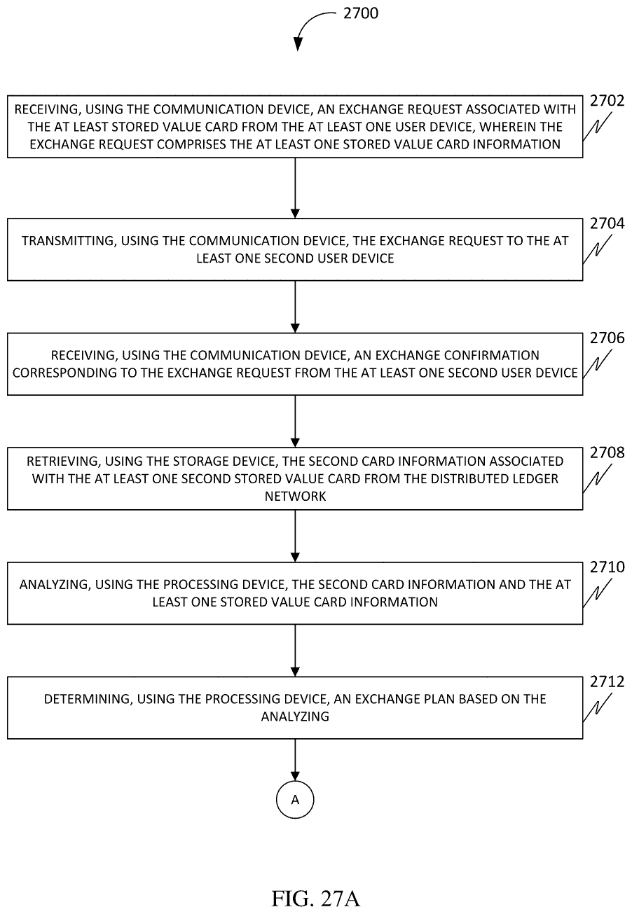

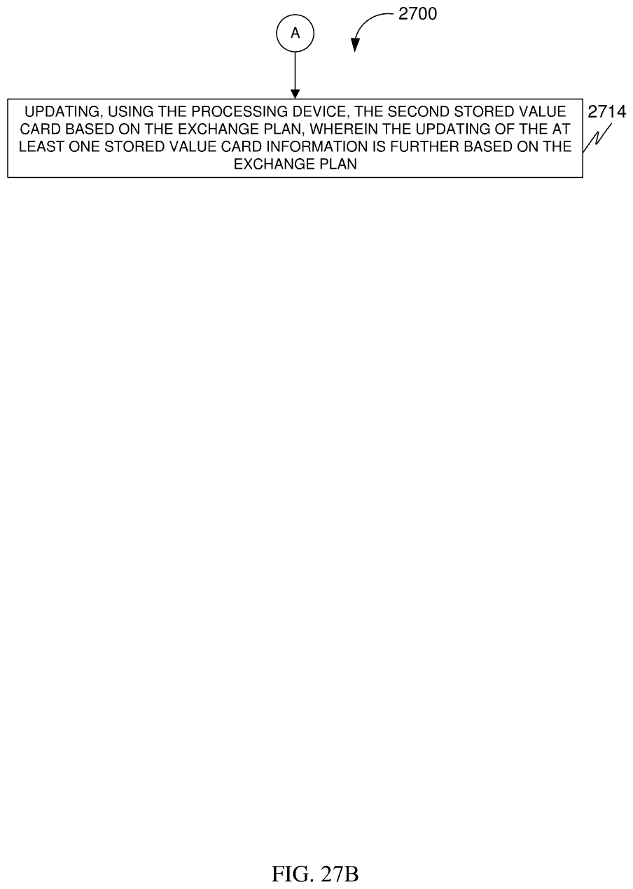

FIG. 27A and FIG. 27B illustrate a flowchart of a method 2700 of facilitating trading a stored value card using blockchain, in accordance with some embodiments. Further, the method 2700 may include a step 2702 of receiving, using the communication device 2902, an exchange request associated with the at least stored value card from the at least one user device, wherein the exchange request comprises the at least one stored value card information. Further, the method 2700 may include a step 2704 of transmitting, using the communication device 2902, the exchange request to the at least one second user device. Further, the method 2700 may include a step 2706 of receiving, using the communication device 2902, an exchange confirmation corresponding to the exchange request from the at least one second user device. Further, the method 2700 may include a step 2708 of retrieving, using the storage device 2904, the second stored value card information associated with the second stored value card from the distributed ledger network. Further, the method 2700 may include a step 2710 of analyzing, using the processing device 2906, the second stored value card information and the at least one stored value card information. Further, the method 2700 may include a step 2712 of determining, using the processing device 2906, an exchange plan based on the analyzing of the second stored value card information and the at least one stored value card information. Further, the exchange plan may present mathematical logic and terms and conditions for exchanging of the at least one stored value card and the second stored value card. Further, the method 2700 may include a step 2714 of updating, using the processing device 2906, the second stored value card based on the exchange plan, wherein the updating of the at least one stored value card information is further based on the exchange plan.

Further, in some embodiments, the method 2700 may include a step of determining, using the processing device 2906, a settlement amount associated with one of the at least one user and the at least one second user based on the exchange plan. Further, in an instance, the settlement amount may be a difference between a monetary value of the at least one stored value card and a monetary value of the second stored value card. Further, the settlement amount (or leftover amount) may be paid by one of the at least one user and the at least one second user to the other. Further, the method 2700 may include a step of transmitting, using the communication device 2902, the settlement amount to one of the at least one user device and the second user device. Further, the method 2700 may include a step of storing, using the storage device 2904, the settlement amount, the exchange request, and the exchange plan in the distributed ledger network.

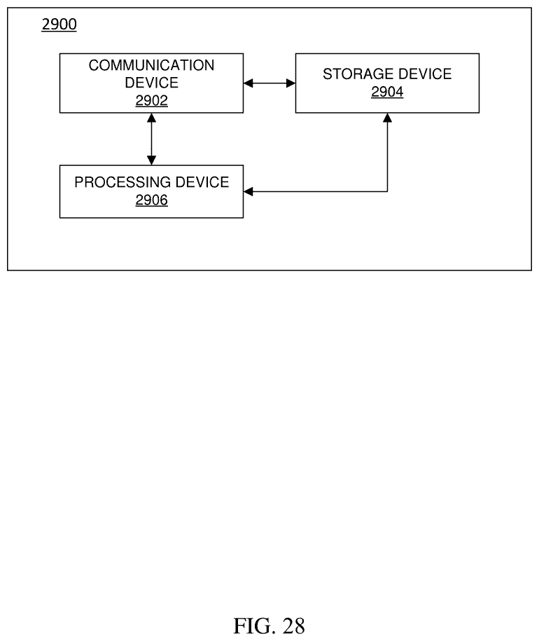

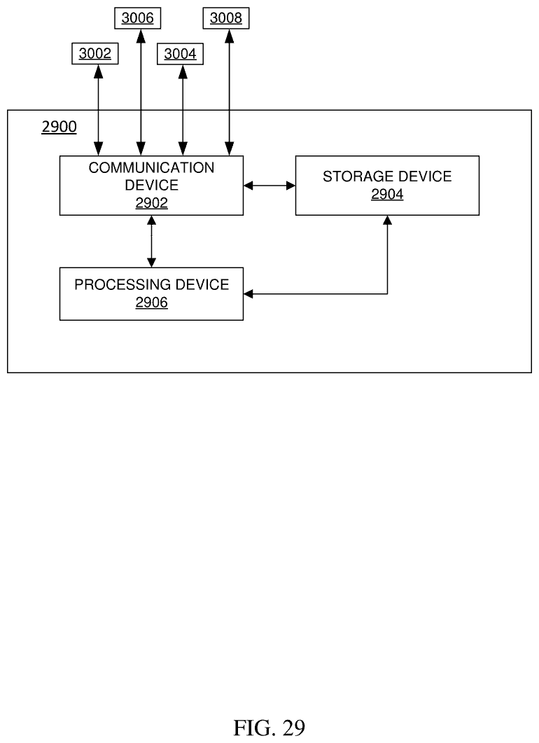

FIG. 28 illustrates a block diagram of a system 2900 of facilitating trading a stored value card using blockchain, in accordance with some embodiments. Accordingly, the system 2900 may include a communication device 2902 configured for receiving a trading request associated with one or more stored value cards (or one or more prepaid access cards) from one or more user devices 3002-3004 (as shown in FIG. 29) associated with one or more users, wherein the trading request indicates that the one or more users want to perform a trading operation of the one or more stored value cards. Further, the communication device 2902 may be configured for transmitting the trading request and one or more stored value card information to one or more second user devices 3006-3008 (as shown in FIG. 29) associated with one or more second users. Further, the communication device 2902 may be configured for receiving a confirmation corresponding to the trading request from the one or more second user devices 3006-3008. Further, the system 2900 may include a storage device 2904 communicatively coupled with the communication device 2902. Further, the storage device 2904 may be configured for retrieving the one or more stored value card information associated with the one or more stored value cards from a distributed ledger network. Further, the one or more stored value card information may include a monetary value associated with the one or more stored value cards. Further, the storage device 2904 may be configured for retrieving a first smart contract from the distributed ledger network. Further, the storage device 2904 may be configured for storing a trading confirmation, the second stored value card information, and the one or more stored value card information in the distributed ledger network. Further, the system 2900 may include a processing device 2906 communicatively coupled with the communication device 2902. Further, the processing device 2906 may be configured for issuing a second stored value card (or a second prepaid access card) to the one or more second users based on the confirmation. Further, the second stored value card may be associated with a second stored value card information. Further, the processing device 2906 may be configured for executing the first smart contract. Further, the processing device 2906 may be configured for updating the one or more stored value card information based on the executing of the first smart contract. Further, the processing device 2906 may be configured for generating the trading confirmation based on the updating.

In some embodiments, a monetary value of the second stored value card may be equivalent to at least a portion of the monetary value of the one or more stored value cards.

In some embodiments, the trading operation may include one or more of issuance, adjustment, purchasing, splitting, selling, transferring, co-using, on-holding, and consolidating the one or more stored value cards between the one or more users and the one or more second users.

Further, in some embodiments, the communication device 2902 may be configured for receiving one or more user data associated with one or more of the one or more users and the one or more second users from one or more of the one or more user devices 3002-3004 and the one or more second user devices 3006-3008. Further, the storage device 2904 may be configured for retrieving a second smart contract from the distributed ledger network based on the receiving of the one or more user data. Further, the storage device 2904 may be configured for storing the one or more user data and one or more user certificates in the distributed ledger network. Further, the processing device 2906 may be configured for executing the second smart contract. Further, the processing device 2906 may be configured for registering one or more of the one or more users and the one or more second users corresponding to the one or more user data based on the executing of the second smart contract. Further, the processing device 2906 may be configured for generating the one or more user certificates corresponding to the one or more of the one or more users and the one or more second users based on the registering.

Further, in some embodiments, the storage device 2904 may be configured for retrieving a fourth smart contract from the distributed ledger network based on the receiving of the trading request. Further, the processing device 2906 may be configured for executing the fourth smart contract. Further, the processing device 2906 may be configured for authenticating the trading request and the one or more users based on the executing of the fourth smart contract. Further, the transmitting of the trading request and the one or more stored value card information may be based on the authenticating.

Further, in some embodiments, the communication device 2902 may be configured for receiving a purchase request from the one or more user devices 3002-3004. Further, the purchase request may indicate that the one or more users may want to purchase one or more assets using the one or more stored value cards. Further, the communication device 2902 may be configured for transmitting a marketplace data to the one or more user devices 3002-3004. Further, the communication device 2902 may be configured for receiving a selection and a payment information corresponding to the one or more assets from the one or more user devices 3002-3004. Further, the updating of the one or more stored value cards may be based on the payment information. Further, the storage device 2904 may be configured for retrieving the marketplace data from the distributed ledger network.

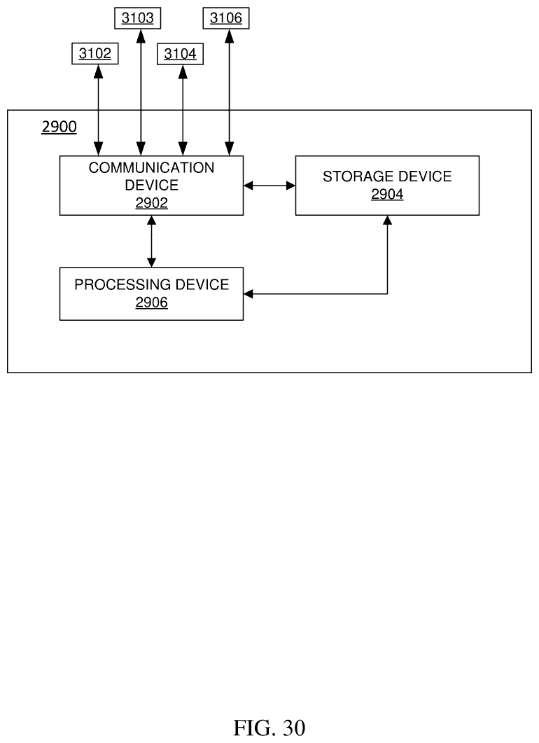

Further, in some embodiments, the communication device 2902 may be configured for receiving a marketplace data from one or more merchant devices 3102-3103 (as shown in FIG. 30) associated with one or more merchants owning a marketplace. Further, the marketplace data may include asset data of one or more assets available in the marketplace. Further, in an embodiment, the one or more assets may include gift cards, vouchers, coupons, etc. Further, the communication device 2902 may be configured for transmitting the marketplace data to the one or more user devices 3002-3004. Further, the communication device 2902 may be configured for receiving a selection corresponding to the one or more assets from the one or more user devices 3002-3004. Further, the communication device 2902 may be configured for transmitting a billing information corresponding to the one or more assets to one or more payment devices 3104-3106 (as shown in FIG. 30). Further, the one or more payment devices 3104-3106 may be owned by the one or merchants. Further, the one or more payment devices 3104-3106 may include a point-of-sales machine, NFC enabled card machine, etc. Further, the one or more payment devices 3104-3106 may be configured for receiving a payment information corresponding to purchase of the one or more assets from the one or more user devices 3002-3004. Further, the communication device 2902 may be configured for receiving the payment information corresponding to the purchase of the one or more assets from the one or more payment devices 3104-3106. Further, the payment information may be associated with the billing information. Further, the updating of the one or more stored value cards may be based on the payment information. Further, in some embodiments, the communication device 2902 may be configured for transmitting the payment information to the one or more merchant devices 3102-3103.

Further, in some embodiments, the communication device 2902 may be configured for receiving a lost request from the one or more user devices 3002-3004. Further, the lost request may indicate that a lost card of the one or more stored value cards may be lost by the one or more users. Further, the lost request may include lost card information associated with the lost card. Further, the storage device 2904 may be configured for retrieving a third smart contract and a stored card information corresponding to the lost card from the distributed ledger network based on the receiving of the lost request. Further, the one or more stored value card information may include the stored card information. Further, the storage device 2904 may be configured for storing a replacement value card information in the distributed ledger network. Further, the updating of the one or more stored value card information may be based on issuing of a replacement card. Further, the processing device 2906 may be configured for executing the third smart contract. Further, the processing device 2906 may be configured for analyzing the one or more stored value card information and the lost card information based on the executing of the third smart contract. Further, the processing device 2906 may be configured for verifying ownership of the lost card based on the analyzing of the one or more stored value card information and the lost card information. Further, the processing device 2906 may be configured for issuing the replacement card corresponding to the lost card based on the verifying. Further, the replacement card may be associated with the replacement value card information.

Further, in some embodiments, the communication device 2902 may be configured for receiving an exchange request associated with the at least stored value card from the one or more user devices 3002-3004. Further, the exchange request may include the one or more stored value card information. Further, the communication device 2902 may be configured for transmitting the exchange request to the one or more second user devices 3006-3008. Further, the communication device 2902 may be configured for receiving an exchange confirmation corresponding to the exchange request from the one or more second user devices 3006-3008. Further, the storage device 2904 may be configured for retrieving the second stored value card information associated with the second stored value card from the distributed ledger network. Further, the processing device 2906 may be configured for analyzing the second stored value card information and the one or more stored value card information. Further, the processing device 2906 may be configured for determining an exchange plan based on the analyzing of the second stored value card information and the at least one stored value card information. Further, the processing device 2906 may be configured for updating the second stored value card based on the exchange plan. Further, the updating of the one or more stored value card information may be based on the exchange plan.

In some embodiments, the processing device 2906 may be configured for determining a settlement amount associated with one of the one or more users and the one or more second users based on the exchange plan. Further, the communication device 2902 may be configured for transmitting the settlement amount to one of the one or more user devices 3002-3004 and the second user device. Further, the storage device 2904 may be configured for storing the settlement amount, the exchange request, and the exchange plan in the distributed ledger network.

FIG. 29 illustrates a block diagram of the system 2900 of facilitating trading the stored value card using blockchain, in accordance with some embodiments.

FIG. 30 illustrates a block diagram of the system 2900 of facilitating trading the stored value card using blockchain, in accordance with some embodiments.

Although the invention has been explained in relation to its preferred embodiment, it is to be understood that many other possible modifications and variations can be made without departing from the spirit and scope of the invention as hereinafter claimed.

What is claimed is:

1. A method of facilitating trading a stored value card using blockchain, the method comprising:
receiving, using a communication device, a trading request associated with at least one stored value card from at least one user device associated with at least one user, wherein the trading request indicates that the at least one user wants to perform a trading operation of the at least one stored value card;
retrieving, using a storage device, at least one stored value card information associated with the at least one stored value card from a distributed ledger network, wherein the at least one stored value card information comprises a monetary value associated with the at least one stored value card;
transmitting, using the communication device, the trading request and the at least one stored value card information to at least one second user device associated with at least one second user;
receiving, using the communication device, a confirmation corresponding to the trading request from the at least one second user device;
issuing, using a processing device, a second stored value card to the at least one second user based on the confirmation, wherein the second stored value card is associated with a second stored value card information;
retrieving, using the storage device, a first smart contract from the distributed ledger network;
executing, using the processing device, the first smart contract;
updating, using the processing device, the at least one stored value card information based on the executing of the first smart contract;
generating, using the processing device, a trading confirmation based on the updating; and
storing, using the storage device, the trading confirmation, the second stored value card information, and the at least one stored value card information in the distributed ledger network.

2. The method of claim 1, wherein a monetary value of the second stored value card is equivalent to at least a portion of the monetary value of the at least one stored value card.

3. The method of claim 1, wherein the trading operation comprises at least one of issuance, adjustment, purchasing, splitting, selling, transferring, co-using, on-holding, and consolidating the at least one stored value card between the at least one user and the at least one second user.

4. The method of claim 1 further comprising:
receiving, using the communication device, at least one user data associated with at least one of the at least one user and the at least one second user from at least one of the at least one user device and the at least one second user device;
retrieving, using the storage device, a second smart contract from the distributed ledger network based on the receiving of the at least one user data;
executing, using the processing device, the second smart contract;
registering, using the processing device, at least one of the at least one user and the at least one second user corresponding to the at least one user data based on the executing of the second smart contract;
generating, using the processing device, at least one user certificate corresponding to the at least one of the at least one user and the at least one second user based on the registering; and
storing, using the storage device, the at least one user data and the at least one user certificate in the distributed ledger network.

5. The method of claim 4 further comprising:
retrieving, using the storage device, a fourth smart contract from the distributed ledger network based on the receiving of the trading request;
executing, using the processing device, the fourth smart contract; and
authenticating, using the processing device, the trading request and the at least one user based on the executing of the fourth smart contract, wherein the transmitting of the trading request and the at least one stored value card information is further based on the authenticating.

6. The method of claim 1 further comprising:
receiving, using the communication device, a purchase request from the at least one user device, wherein the purchase request indicates that the at least one user wants to purchase at least one asset using the at least one stored value card;
retrieving, using the storage device, a marketplace data from the distributed ledger network;
transmitting, using the communication device, the marketplace data to the at least one user device;
receiving, using the communication device, a selection and a payment information corresponding to the at least one asset from the at least one user device, wherein the updating of the at least one stored value card information is further based on the payment information.

7. The method of claim 1 further comprising:
receiving, using the communication device, a marketplace data from at least one merchant device associated with at least one merchant owning a marketplace, wherein the marketplace data comprises asset data of at least one asset available in the marketplace;
transmitting, using the communication device, the marketplace data to the at least one user device;
receiving, using the communication device, a selection corresponding to the at least one asset from the at least one user device;
transmitting, using the communication device, a billing information corresponding to the at least one asset to at least one payment device, wherein the at least one payment device is configured for receiving a payment information corresponding to purchase of the at least one asset from the at least one user device; and
receiving, using the communication device, the payment information corresponding to the purchase of the at least one asset from the at least one payment device, wherein the updating of the at least one stored value card information is further based on the payment information.

8. The method of claim 1 further comprising:
receiving, using the communication device, a lost request from the at least one user device, wherein the lost request indicates that a lost card of the at least one stored value card is lost by the at least one user, wherein the lost request comprises lost card information associated with the lost card;
retrieving, using the storage device, a third smart contract and a stored card information corresponding to the lost card from the distributed ledger network based on the receiving of the lost request, wherein the at least one stored value card information comprises the stored card information;
executing, using the processing device, the third smart contract;
analyzing, using the processing device, the at least one stored value card information and the lost card information based on the executing of the third smart contract;
verifying, using the processing device, ownership of the lost card based on the analyzing of the at least one stored value card information and the lost card information;
issuing, using the processing device, a replacement card corresponding to the lost card based on the verifying, wherein the replacement card is associated with a replacement value card information;
storing, using the storage device, the replacement value card information in the distributed ledger network, wherein the updating of the at least one stored value card information is further based on the issuing.

9. The method of claim 1 further comprising:
receiving, using the communication device, an exchange request associated with the at least stored value card from the at least one user device, wherein the exchange request comprises the at least one stored value card information;
transmitting, using the communication device, the exchange request to the at least one second user device;
receiving, using the communication device, an exchange confirmation corresponding to the exchange request from the at least one second user device;
retrieving, using the storage device, the second stored value card information associated with the second stored value card from the distributed ledger network;
analyzing, using the processing device, the second stored value card information and the at least one stored value card information;
determining, using the processing device, an exchange plan based on the analyzing of the second stored value card information and the at least one stored value card information; and
updating, using the processing device, the second stored value card information based on the exchange plan, wherein the updating of the at least one stored value card information is further based on the exchange plan.

10. The method of claim 9 further comprising:
determining, using the processing device, a settlement amount associated with one of the at least one user and the at least one second user based on the exchange plan;
transmitting, using the communication device, the settlement amount to one of the at least one user device and the second user device; and
storing, using the storage device, the settlement amount, the exchange request, and the exchange plan in the distributed ledger network.

11. A system of facilitating trading a stored value card using blockchain, the system comprising:
a communication device configured for:
receiving a trading request associated with at least one stored value card from at least one user device associated with at least one user, wherein the trading request indicates that the at least one user wants to perform a trading operation of the at least one stored value card;
transmitting the trading request and at least one stored value card information to at least one second user device associated with at least one second user; and
receiving a confirmation corresponding to the trading request from the at least one second user device;
a storage device communicatively coupled with the communication device, wherein the storage device is configured for:
retrieving the at least one stored value card information associated with the at least one stored value card from a distributed ledger network, wherein the at least one stored value card information comprises a monetary value associated with the at least one stored value card;
retrieving a first smart contract from the distributed ledger network; and
storing a trading confirmation, a second stored value card information, and the at least one stored value card information in the distributed ledger network; and
a processing device communicatively coupled with the communication device, wherein the processing device is configured for:
issuing a second stored value card to the at least one second user based on the confirmation, wherein the second stored value card is associated with the second stored value card information;
executing the first smart contract;
updating the at least one stored value card information based on the executing of the first smart contract; and
generating the trading confirmation based on the updating.

12. The system of claim 11, wherein a monetary value of the second stored value card is equivalent to at least a portion of the monetary value of the at least one stored value card.

13. The system of claim 11, wherein the trading operation comprises at least one of issuance, adjustment, purchasing, splitting, selling, transferring, co-using, on-holding, and consolidating the at least one stored value card between the at least one user and the at least one second user.

14. The system of claim 11, wherein the communication device is further configured for receiving at least one user data associated with at least one of the at least one user and the at least one second user from at least one of the at least one user device and the at least one second user device, wherein the storage device is configured for:
retrieving a second smart contract from the distributed ledger network based on the receiving of the at least one user data; and
storing the at least one user data and at least one user certificate in the distributed ledger network, wherein the processing device is further configured for:
executing the second smart contract;
registering at least one of the at least one user and the at least one second user corresponding to the at least one user data based on the executing of the second smart contract; and
generating the at least one user certificate corresponding to the at least one of the at least one user and the at least one second user based on the registering.

15. The system of claim 14, wherein the storage device is further configured for retrieving a fourth smart contract from the distributed ledger network based on the receiving of the trading request, wherein the processing device is further configured for:
executing the fourth smart contract; and
authenticating the trading request and the at least one user based on the executing of the fourth smart contract, wherein the transmitting of the trading request and the at least one stored value card information is further based on the authenticating.

16. The system of claim 11, wherein the communication device is further configured for:
receiving a purchase request from the at least one user device, wherein the purchase request indicates that the at least one user wants to purchase at least one asset using the at least one stored value card;
transmitting a marketplace data to the at least one user device; and
receiving a selection and a payment information corresponding to the at least one asset from the at least one user device, wherein the updating of the at least one stored value card information is further based on the payment information, wherein the storage device is further configured for retrieving the marketplace data from the distributed ledger network.

17. The system of claim 11, wherein the communication device is further configured for:
receiving a marketplace data from at least one merchant device associated with at least one merchant owning a marketplace, wherein the marketplace data comprises asset data of at least one asset available in the marketplace;
transmitting the marketplace data to the at least one user device;
receiving a selection corresponding to the at least one asset from the at least one user device;
transmitting a billing information corresponding to the at least one asset to at least one payment device, wherein the at least one payment device is configured for receiving a payment information corresponding to purchase of the at least one asset from the at least one user device; and
receiving the payment information corresponding to the purchase of the at least one asset from the at least one payment device; wherein the updating of the at least one stored value card information is further based on the payment information.

18. The system of claim 11, wherein the communication device is further configured for receiving a lost request from the at least one user device, wherein the lost request indicates that a lost card of the at least one stored value card is lost by the at least one user, wherein the lost request comprises lost card information associated with the lost card, wherein the storage device is further configured for:
retrieving a third smart contract and a stored card information corresponding to the lost card from the distributed ledger network based on the receiving of the lost request, wherein the at least one stored value card information comprises the stored card information; and
storing a replacement value card information in the distributed ledger network, wherein the updating of the at least one stored value card information is further based on issuing of a replacement card, wherein the processing device is further configured for:
executing the third smart contract;
analyzing the at least one stored value card information and the lost card information based on the executing of the third smart contract;
verifying ownership of the lost card based on the analyzing of the at least one stored value card information and the lost card information; and
issuing the replacement card corresponding to the lost card based on the verifying, wherein the replacement card is associated with the replacement value card information.

19. The system of claim 11, wherein the communication device is further configured for:
receiving an exchange request associated with the at least stored value card from the at least one user device, wherein the exchange request comprises the at least one stored value card information;
transmitting the exchange request to the at least one second user device; and
receiving an exchange confirmation corresponding to the exchange request from the at least one second user device, wherein the storage device is further configured for retrieving the second stored value card information associated with the second stored value card from the distributed ledger network, wherein the processing device is further configured for:
analyzing the second stored value card information and the at least one stored value card information;
determining an exchange plan based on the analyzing of the second stored value card information and the at least one stored value card information; and
updating the second stored value card information based on the exchange plan, wherein the updating of the at least one stored value card information is further based on the exchange plan.

20. The system of claim 19, wherein the processing device is further configured for determining a settlement amount associated with one of the at least one user and the at least one second user based on the exchange plan, wherein the communication device is further configured for transmitting the settlement amount to one of the at least one user device and the second user device, wherein the storage device is further configured for storing the settlement amount, the exchange request, and the exchange plan in the distributed ledger network.
